(19) United States
(12) Patent Application Publication
(10) Pub. No.: US 2014/0222702 A1
(43) Pub. Date: Aug. 7, 2014

(54) SYSTEMS AND METHODS FOR SEARCHING FOR PROFESSIONALS WITHIN AN ONLINE COMMUNITY

(71) Applicant: TaxConnections, Inc., La Jolla, CA (US)

(72) Inventor: Kathleen Jennings, La Jolla, CA (US)

(73) Assignee: TaxConnections, Inc., La Jolla, CA (US)

(21) Appl. No.: 14/091,277

(22) Filed: Nov. 26, 2013

Related U.S. Application Data
(63) Continuation-in-part of application No. 13/853,984, filed on Mar. 29, 2013.
(60) Provisional application No. 61/731,346, filed on Nov. 29, 2012.
(60) Provisional application No. 61/618,590, filed on Mar. 30, 2012.
(60) Provisional application No. 61/618,595, filed on Mar. 30, 2012.
(60) Provisional application No. 61/618,597, filed on Mar. 30, 2012.

(51) Int. Cl. G06Q 50/00; G06Q 10/00

(52) U.S. Cl. CPC G06Q 50/01; G06Q 10/00
USPC 705/319

(57) ABSTRACT

Systems and methods for searching for professionals within an online community. In an embodiment, a database is provided comprising member information for each of a plurality of members, including professional members and non-professional members. Activity information concerning one or more interactions between one or more of the professional members and a web application is tracked and stored. In addition, feedback information received for one or more of the professional members is tracked and stored. Search requests may be received, and for each of the search requests, two or more of the professional members may be identified based on member information and search criteria, an order can be determined for the identified professional members based on the stored activity information and feedback information, and a list can be generated comprising the identified professional members in the determined order.

### PRIORITY

This application claims priority, as a continuation in part, to U.S. patent application Ser. No. 13/853,984, filed on Mar. 29, 2013, and titled “Systems and Methods for Ranking and Filtering Professionals Based on User Input and Activity and Interfacing with Professionals within an Online Community,” which claims priority to U.S. Provisional Patent App. Nos. 61/618,590, 61/618,595, and 61/618,597, each of which were filed on May 30, 2013, and further claims priority to U.S. Provisional Patent App. No. 61/731,346, filed on Nov. 29, 2012, and titled “Systems and Methods for Aggregating Syndicated Content for Professionals within a Professional Website,” the entireties of all of which are hereby incorporated herein by reference.

### BACKGROUND

1. Field of the Invention

The embodiments described herein are generally directed to an online community of professionals and non-professionals, and, more particularly, to marketing professionals within the online community based on the professionals' activities within the community and/or feedback from the community.

2. Description of the Related Art

Conventionally, locating a professional, such as a tax professional, is difficult. Historically, most individuals identify a tax professional by asking someone they know for a referral. However, this is not necessarily an efficient or effective method of finding a professional. Different individuals may be differently situated and have different needs, preferences, desires, etc. Accordingly, a tax professional that is appropriate for one individual may not be appropriate for the individual to whom they are being recommended or referred.

For example, a first individual may be employed with a modest salary, whereas a second individual may be a small business owner with many investments. A tax professional that is best suited for the first individual may not be as well-suited for the second individual. Moreover, the two individuals may have vastly different personalities and preferences, which influence the type of professional with which they would be comfortable. Of course, businesses and organizations can also have entirely different needs.

In addition, most professionals (e.g., tax professionals) are either too busy, unwilling, or otherwise unable to effectively market themselves or establish a brand around the areas and expertise that they offer. Not only does this make it difficult for potential clients to identify suitable professionals to provide a desired service (e.g., tax advice), but it also makes it difficult for employers to identify suitable professionals for potential job opportunities (e.g., tax opportunities).

What has been lacking is a system or method that precipitates a community for professionals to interact and market themselves, while providing a way for entities in need of professional services to leverage this community in order to each find a professional that suits that entity's individual tastes and/or needs.

### SUMMARY

Accordingly, systems and methods are disclosed for creating and nurturing an online community of professionals, and ranking, filtering, and/or presenting those professionals based on their activities within that community.

In an embodiment, a method for searching for professionals within an online community is provided. The method may comprise using at least one hardware processor to: manage at least one database comprising member information for each of a plurality of members, wherein the plurality of members comprise a plurality of professional members and a plurality of non-professional members; store activity information for one or more interactions between one or more of the plurality of professional members and a web application; store feedback information received for one or more of the plurality of professional members; receive one or more search requests from at least one of the plurality of non-professional members, wherein each of the one or more search requests comprises one or more search criteria; and for each of the one or more search requests, identify two or more of the plurality of professional members based on the membership information for each of the two or more professional members and the one or more search criteria, determine an order for the identified two or more professional members based on the activity information and the feedback information for the identified two or more professional members, and generate a list comprising the identified two or more professional members in the determined order.

In an additional embodiment, a system for searching for professionals within an online community is provided. The system may comprise: at least one hardware processor; at least one database comprising member information for each of a plurality of members, wherein the plurality of members comprise a plurality of professional members and a plurality of non-professional members; and one or more executable software modules configured to, when executed by the at least one hardware processor, store activity information for one or more interactions between one or more of the plurality of professional members and a web application, store feedback information received for one or more of the plurality of professional members, receive one or more search requests from at least one of the plurality of non-professional members, wherein each of the one or more search requests comprises one or more search criteria, and for each of the one or more search requests, identify two or more of the plurality of professional members based on the membership information for each of the two or more professional members and the one or more search criteria, determine an order for the identified two or more professional members based on the activity information and the feedback information for the identified two or more professional members, and generate a list comprising the identified two or more professional members in the determined order.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an infrastructure in which a server platform may operate according to the described methods, according to an embodiment;

FIG. 2 illustrates an example home page, according to an embodiment;

FIG. 3 illustrates an example searchable directory of professionals, according to an embodiment;

FIG. 4 illustrates an example question details interface, according to an embodiment;

FIGS. 5A-5Q illustrate example user interfaces for a registration process, according to an embodiment;

FIG. 6 illustrates an example profile page, according to an embodiment;

FIG. 7 illustrates aspects of an example virtual boardroom, according to an embodiment;

FIG. 8 illustrates aspects of an example virtual boardroom, according to an embodiment;

FIGS. 9A-9D illustrate example user interfaces for an online community, according to an embodiment;

FIG. 10 illustrates an example user interface for listing job opportunities, according to an embodiment;

FIG. 11A illustrates an example user interface for a panel, according to an embodiment;

FIG. 11B illustrates an example panel dashboard for a panelist, according to an embodiment; and

FIG. 12 illustrates a processing system on which one or more of the processes described herein may be executed, according to an embodiment.

### DETAILED DESCRIPTION

In embodiments, systems and methods are described for ranking, filtering, or otherwise presenting professionals based on their activities within and/or feedback from a community of professionals. Embodiments described herein will primarily be discussed with respect to a community of tax professionals. These tax professionals may come from accounting firms, corporations, governments tax agencies, law firms, tax associations, tax consultancies, tax services firms, sole proprietorships, universities, etc. However, it should be understood that the embodiments described herein may be adapted for any type of profession, including combinations or mixtures of two or more different types of professions.

System Overview

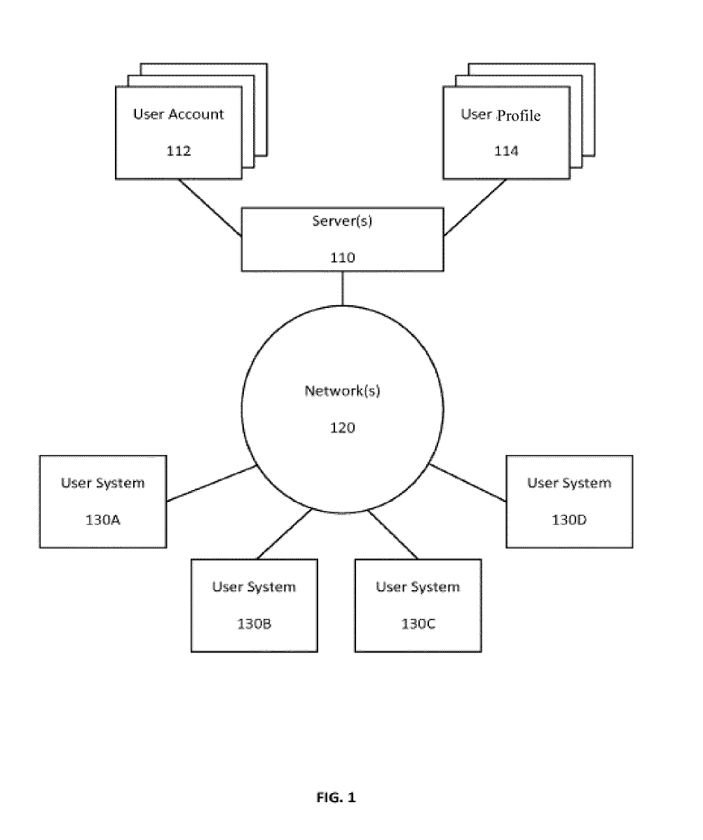

FIG. 1 illustrates an example system for supporting a professional community with ranking and filtering capabilities, according to an embodiment. The system may comprise a server platform 110 comprising a set of one or more servers which host and/or execute one or more of the various functions, processes, and/or software modules described herein. In addition, server(s) 110 are communicatively connected to one or more user systems 130 via one or more network(s) 120. Network(s) 120 may comprise the Internet, and server(s) 110 may communicate with user system(s) 130 through the Internet using standard transmission protocols, such as HyperText Transfer Protocol (HTTP), Secure HTTP (HTTPS), File Transfer Protocol (FTP), FTP Secure (FTPS), SSH FTP (SFTP), and the like, as well as proprietary protocols. In an embodiment, server(s) 110 may not be dedicated servers, and may instead be cloud instances, which utilize shared resources of one or more servers. It should also be understood that server(s) 110 can be, but are not required to be, collocated. Furthermore, while server(s) 110 are illustrated as being connected to various systems through a single set of network(s) 120, it should be understood that server(s) 110 may be connected to the various systems via different sets of one or more networks. For example, server(s) 110 may be connected to a subset of user systems 130 via the Internet, but may be connected to one or more other user systems 130 via an intranet. It should also be understood that user system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, Automated Teller Machines, and the like. In addition, while only a few user systems 130 and one set of server(s) 110 are illustrated, it should be understood that the network may comprise any number of user systems and sets of server(s).

Server(s) 110 may comprise web servers which host one or more web applications, such as websites or web services. In embodiments in which a website is provided, the website may comprise one or more user interfaces, including, for example, webpages generated in HyperText Markup Language (HTML) or other language. Server(s) 110 transmit or serve these user interfaces in response to requests from user system(s) 130. In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to server(s) 110 and the responses from server(s) 110, including the user interfaces, may both be communicated through network(s) 120, which may include the Internet, using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (not shown) that are locally and/or remotely accessible to the server(s) 110. Server(s) 110 may also respond to other requests from user system(s) 130.

Server(s) 110 may further comprise, be communicatively coupled with, or otherwise have access to one or more database(s). For example, server(s) 110 may comprise one or more database servers which manage one or more databases. A user system 130 or application executing on server(s) 110 may submit data (e.g., user data, form data, etc.) to be stored in the database(s), and/or request access to data stored in such database(s). Any suitable database may be utilized, including, without limitation, MySQL, Oracle, IBM, Microsoft SQL, Sybase, Access, and the like, including cloud-based database instances. Data may be sent to the server(s) 110, for instance, using the well-known POST request supported by HTTP, via FTP, etc. This data, as well as other requests, may be handled, for example, by server-side web technology, such as a servlet or other software module, executed by server(s) 110.

In embodiments in which a web service is provided, server(s) 110 may receive requests from user system(s) 130, and provide responses in eXtensible Markup Language (XML) and/or any other suitable or desired format. In such embodiments, server(s) 110 may provide an application programming interface (API) which defines the manner in which user system(s) 130 may interact with the web service. Thus, user system(s) 130, which may themselves be servers, can define their own user interfaces, and rely on the web service to implement the backend processes, functionality, storage, etc., described herein. For example, in such an embodiment, a client application executing on one or more user system(s) 130 may interact with a server application executing on server(s) 110 to execute one or more or a portion of one or more of the various functions, processes, and/or software modules described herein. The client application may be “thin,” in which case processing is primarily carried out server-side by server(s) 110. A simple example of a thin client application is a browser application, which simply requests, receives, and renders web pages at user system(s) 130, while server(s) 110 are responsible for generating the web pages and managing database functions. Alternatively, the client application may be “thick,” in which case processing is primarily carried out client-side by user system(s) 130. It should be understood that the client application may perform an amount of processing, relative to server(s) 110, at any point along this spectrum between “thin” and “thick,” depending on the design goals of the particular implementation. In any case, the application, which may wholly reside on either the server(s) or user system(s) or be distributed between the server(s) or user system(s), can comprise one or more executable software modules that implement one or more of the processes or functions of the application(s) described herein.

Web Application Overview

In an embodiment, server(s) 110, which may also be referred to as platform 110, comprises a web application which provides one or more user interfaces that enable professionals and potential clients to interact with each other. The web application may comprise one or more user interfaces which allow professionals, such as tax professionals, to establish a user account 112 (e.g., username/email and password) which provides a professional with access to platform 110, and/or a user profile 114 which comprises information about the professional (e.g., name, contact information, credentials, qualifications, etc.). In addition, the web application may comprise one or more user interfaces which allow other users (e.g., seeking a professional) to establish a user account 112 (e.g., username/email and password) which provides a user with access to the platform 110 and/or or a user profile 114 which comprises information about the user (e.g., name, contact information, etc.). Both the user account and user profile information for professionals and other users may be obtained through a registration process, described in more detail elsewhere herein.

Users can access platform 110 to interact with and select professionals. It should be understood that these interactions may include an interaction between a professional and professional, as well as an interaction between a non-professional (e.g., an entity seeking professional services) and a professional. Also, while the embodiments disclosed herein will primarily be described in relation to tax professionals, it should be understood that the disclosed embodiments may be adapted for any type of professional.

In an embodiment, the web application comprises a website, and the user interfaces of the web application comprise web pages which are consistent throughout the web application. For instance, the web application may comprise a web server that serves dynamic and/or static web pages in response to requests from user system(s) 130. Each web page may comprise a consistent sign-up input and login input (e.g., if the user has not registered or logged in to the web application), logout input (e.g., if the user has registered and logged in to the web application), search input, header and footer, and/or feedback bar. The sign-up input allows a user to register with the web application. The login input allows a registered user (also referred to herein as a “member”) to log in to the web application (i.e., access functionality of the web application that is unavailable to unregistered users). The logout input allows a user who has logged in to the web application to sign out of his or her account.

Users, including professionals and those seeking a professional, can access the web application using a user system 130, which may comprise any one or more of a variety of computing devices capable of communications over network(s) 120 (e.g., comprising the Internet). In an embodiment, users may comprise visitors, free members and/or non-professional members, and professional members. A visitor is someone who is visiting the web application, but who has not registered with the web application, or who has registered but has not logged in to the web application. A free member or non-professional member is someone who has registered with the web application for the purposes of finding a professional or asking a question and has not registered as a professional. In an embodiment, there is no cost to a free member to use the web application. A professional member is a professional (e.g., tax professional) that has registered with the web application to promote his or her expertise (e.g., tax expertise) in the web application's interactive directory of professionals that is available to visitors, free members, and other tax professional members (e.g., searching for expertise outside of their own area of expertise). Additionally, users may further comprise an employer or other organizational user (e.g., searching for professional services and/or potential job applicants). In an embodiment, a professional member must purchase his or her membership (e.g., as a subscription, such as a monthly subscription). However, it should be understood that, in other embodiments, professional members or subsets of professional members may not be required to purchase their memberships. It should also be understood that, in embodiments which utilize subscriptions, those subscriptions may be tiered, such that lower-tiered subscriptions have more restrictions and/or less access to features of platform 110 than higher-tiered subscriptions.

1. Header

Each webpage for the website of the web application may comprise a header with inputs (e.g., hyperlinks) for accessing one or more other user interfaces. In an embodiment, the header may comprise a different color scheme depending on the type of member. For example, a visitor and a free member or non-professional member may see a first header (e.g., blue-themed header), whereas a professional member may see a second header (e.g., green-themed header). The first header may comprise hyperlinks for returning to a home page or landing page of the website, accessing a user interface for finding a tax professional, asking a tax question, viewing events, viewing a tax blog, and/or viewing tax polls. In addition, the first header may comprise a navigation drop-down or other input—e.g., labeled “Welcome [Name of Free User]”—that allows a user to select one or more user interfaces or search subjects, such as a tax connections interface, which allows a free member to view professionals with whom he or she has connected, a tax questions interface, which allows the free member to view questions which he or she has asked (including any provided answers), and/or an account settings interface, which allows the free member to view or modify his or her account 112 and/or profile 114. The second header may comprise the same hyperlinks as the first header, but may comprise a navigation drop-down—e.g., labeled “Welcome [Name of Tax Professional]”—which provides different options that allow a professional member to access the additional functionality of the web application that is available to professional members. For instance, the navigation drop-down of the second header may provide a list of tools available to the professional member, such as links to user interfaces for viewing a profile of the professional member, editing a profile of the professional member, entering the professional member's tax boardroom, viewing tax connections, viewing tax questions asked, viewing tax questions answered, viewing and editing account settings, etc. The drop-down may also comprise a link to an inbox of an internal messaging system (e.g., the messaging module described elsewhere herein) provided by the web application.

In an embodiment, the header may further comprise a search bar that is interfaced with a search engine. The search bar may comprise an input (e.g., text box) for entering keywords and/or other criteria, and a drop-down menu (e.g., the navigation drop-down discussed above) for selecting a specific portion or type of data to be searched. For example, the drop-down menu may allow a user to elect to search stored tax questions, a directory of tax professionals, or both. This allows a user to search a specific part of the web application for better results. If the user selects tax questions, then the user may enter keywords into the textbox, and the search engine will utilize the entered keywords to retrieve stored questions (e.g., from or using a questions module discussed elsewhere herein) that have been previously answered by a tax professional through the web application. If the user selects tax professionals, then the search engine will utilize the entered keywords or criteria to retrieve a list of one or more tax professional members (e.g., from or using a professionals-search module, described elsewhere herein) whose user profiles 114 contain the keywords or match the criteria.

2. Footer

Each user interface may also comprise a footer, which provides links to various aspects of the website, including, without limitation, an about us page (e.g., biographies of team members of the operator of the web application), a contact us page (e.g., a form for submitting questions, concerns, or comments to the operator of the web application), a Frequently Asked Questions (FAQ) page, a guidelines page (e.g., listing guidelines for posting content to the web application), media/press page (e.g., a form for journalists and media to submit questions to the operator of the web application), memberships page (e.g., information regarding the benefits of becoming a member), privacy policy page, site map, tax jobs page (e.g., listing employment opportunities), terms of use page, tutorials (e.g., basic instructions on how to utilize the web application), report inappropriate content page (e.g., allowing users to flag content as inappropriate, or report a violation of intellectual property rights, such as copyrights), and/or additional user interfaces or items.

3. Feedback Button

Each user interface may also comprise a feedback button. For example, the feedback button may be consistently and conveniently placed along the middle left of every web page. When a user clicks on the feedback button, a pop-up feedback user interface may appear that includes one or more inputs comprising text fields for the user to fill in. If a user has logged in to the web application, some of these text fields may be automatically pre-populated for the user based on the user's account 112 and/or profile 114. The feedback user interface may comprise text fields for inputting the user's name, email address, company, location, and comments, suggestions, or other feedback that the user wishes to submit.

4. Home Page

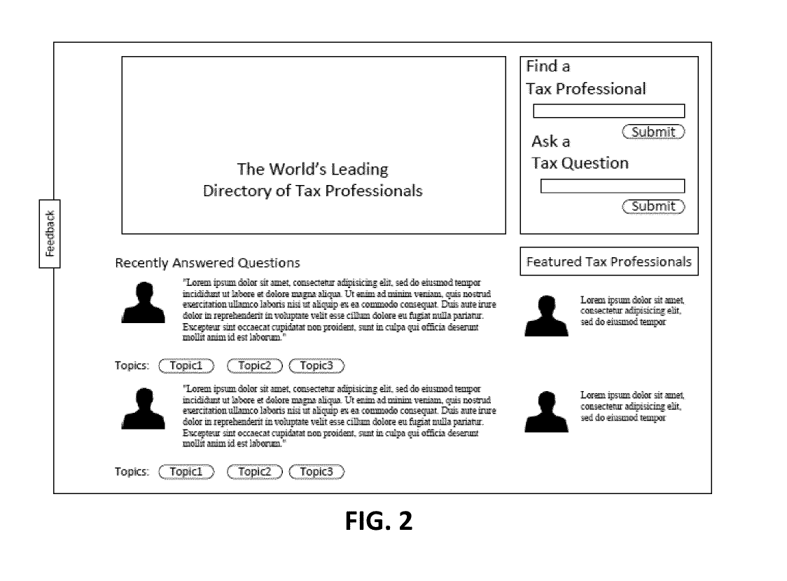

In an embodiment, the user interfaces of the web application comprise a home page. An example of such a home page is illustrated in FIG. 2. The purpose of the home page may be to communicate the web application's purpose of being an online directory resource and an interactive worldwide directory of tax professionals. The home page may also present users with all or some of the major options available to them while visiting the website. The home page may display photographs of numerous cities from around the world to provide a global feel to the web application.

In addition to the consistent header, footer, and/or feedback button, the home page may contain two search boxes: (a) a find-a-professional search box which interfaces with and provides inputs to a professionals-search module, and (b) an ask-a-question search box which interfaces with and provides inputs to a questions module. The professionals-search module provides a simple, intuitive interface for users to do a text-based search for a tax professional. The questions-search module provides a simple, intuitive interface for users to locate questions and answers that are of interest to the user. Both search boxes may be prominently placed for quick and easy access.

The home page may comprise a recently-answered-questions frame or panel, which lists the most recently answered questions between non-professional users and tax professionals. The recently-answered-questions frame may contain a predetermined number (e.g., five) of the most recently answered questions. These questions and answers can be streamed from a questions module of the web application. The recently-answered-questions frame on the home page may feature the tax question that was asked, information about the tax professional who answered the question, how long ago the question was answered, a tax topic or topics associated with the question (e.g., displayed as tags), and at least a portion of the answer to the question (e.g., the first sentence or line of the answer). The recently-answered-questions frame may also comprise an input (e.g., button) comprising a link to a user interface of the questions module for browsing all tax questions and answers.

The home page may also comprise a featured-professionals frame, which is an above-the-fold area for validated tax professionals. One or more algorithms may be used to determine how the featured-professionals frame is populated. The algorithm(s) may be driven by analytics collected by the web application. For example, the algorithm may select a predetermined number of the most recently validated tax professionals. The featured-professionals frame may list the selected tax professionals from most recent to least recent, and for each professional, include the tax professional's profile information, including an image, name, title, primary areas of tax expertise, current employer, location (e.g., city and state), etc. In an embodiment, users can click on either the name or the tax professional's profile image to view the tax professional's complete profile page.

5. Professionals-Search Module

In an embodiment, the web application comprises a professionals-search module. This module may comprise a user interface or search page that can be accessed, for example, using the find-a-professional search box and/or a find-a-professional link in the header of one or more web pages of the website. A user may input a search query to the professionals-search module to obtain search results. In an embodiment, a user may search for tax professionals based on first, middle, and/or last name, a blog, twitter account, YouTube™ video, title, expertise, years of experience, location, degrees, certifications, keyword, etc.

A professionals-search user interface may comprise the results of a search, which may comprise a list of tax professionals identified for a given query. The list of tax professionals may comprise basic information for each tax professional matching the given search criteria and filters, including, without limitation, a profile image, name, title, current and/or recent employer, tax expertise, and/or current location (e.g., city and state). The user can click on one of the tax professionals in the list to be taken to the tax professional's profile page. Since the search page may only return a certain number of results per page (e.g., ten, twenty, fifty, or a user-specified number), at the bottom of the search results, there may be basic pagination buttons. A user can click a page number or “next” button to view other pages of the search results.

The professionals-search user interface may comprise a search refinement feature. For example, the user interface may comprise a frame (e.g., on the left side of the interface) that filters a search based on various criteria. The frame may comprise content filters that a user may check (e.g., using checkbox inputs) to add a filter to the search. Examples of such filters include, without limitation, location, expertise, title, type of organization, industry, recent employer, languages spoken, or any other criteria that can be matched to information in a professional member's profile.

In an embodiment, after an initial query, one or more filters presented to the user on the professionals-search user interface may based on the search results that were returned by the initial query. For example, there may be a filter for tax expertise that displays various tax expertise values relevant to the search results returned by the initial query. In other words, the tax expertise values may represent all of the fields of tax expertise possessed by the tax professionals returned in the search results. If a user then clicks a checkbox next to one or more of the tax expertise values, the search results may be dynamically and immediately refined so that only tax professionals matching the newly-selected tax expertise filter will be displayed. Alternatively, the updated filter can be resubmitted and a new professionals-search user interface can be generated for the updated search results. As an example, if the user selects the checkbox next to a “Central America” tax expertise filter, the search results will be filtered to only those tax professionals who have listed “Central America” as one of their areas of tax expertise. As more tax professionals register with the web application, the list of possible filter criteria may grow or otherwise change to accommodate information collected about the registered tax professionals. Data that is received through the web application and the terms that are collected by various modules of the web application (e.g., professionals-search module, questions module, events module, blog module, polls module, etc.) and other logistics of the web application can be used to determine and improve search algorithms.

In an embodiment, visitors and/or free members can search for professional members that match certain user-specified criteria, such as a geographic location, area of expertise, language, years of experience, and/or any other criteria that may be relevant or useful. Professional members can be selected and/or filtered by a search engine according to various algorithms that take into account one or more of the professional member's user profile information, demographics, areas of focus, experience, etc. The professional members can also be selected and/or filtered based on data related to the searching user, such as the searching user's demographics, needs, location, user profile information, questions asked, etc. In addition, the professional members can be selected and/or filtered based on other information, such as the types of answers the professional members have given to one or more questions posed using the web application, the frequency of answers that the professional members have given, peer ratings of the professional members (e.g., representing feedback to a professional's answer to a question, etc.), client ratings of the professional members (e.g., representing feedback to a professional's answer to a question, feedback about a professional's service of a client, etc.), and/or other activities on the web application (e.g., number or frequency of answers provided by the professional, ratings, etc.).

As an illustrative, non-limiting example, if a particular professional member is located in California and speaks Japanese (e.g., determined from the professional member's profile) and often works with small business owners (e.g., determined because the professional member frequently answers questions from users with profiles indicating that they operate or represent a small business or questions tagged with a “small business” topic, has submitted blog entries regarding small businesses and/or associated with a “small business” topic, has attended events related to small businesses and/or associated with a “small business” topic, etc.), then when a small business owner of Japanese descent, living on the West Coast (e.g., determined based on the small business owner's user profile) searches for a professional member, the search engine may identify the particular professional and present him or her as an option to the small business owner. Moreover, if the professional member often responds to questions from or relating to small business owners through the web application, and those answers are highly rated (e.g., based on feedback from other users), then the search engine may be configured to be more likely to identify the particular professional member in the small business owner's search. Thus, search results can be influenced, not only by the amount of activity that a professional member has with the web application or other users, but by the quality of that activity as determined by ratings and/or other feedback.

In an embodiment, the search engine may be driven by algorithms that are run on data recorded over time. In other words, over time, an application on platform 110 may generate and store data related to prior matches between users and professionals. This data may also comprise feedback about the satisfaction of one or both parties to the match (e.g., received directly from one or more of the parties, determined based on the consummation of a connection or ongoing relationship between the parties, etc.). As this data grows, pattern recognition and other algorithms can be used to determine what drives compatible matches, and these determinations can be used by the search engine to improve search results. For example, the search engine can utilize this analysis of historical data to weight certain criteria, such as questions asked, location, profile information, and/or other search criteria, when responding to search requests.

In an embodiment, professionals may be weighted by the web application for searching purposes based on their participation and activities in the online community provided by the web application. Thus, the more a professional participates in the online community, the higher that professional may be weighted in user search results, providing an incentive for professional members to be active within the online community. Examples of participation criteria that may be used to weight professionals may include, without limitation, the completeness of the professional's profile, participation in tax forums, whether the professional has become an expert panel member, authorship of a blog, commenting on blogs, number of clients in the professional's boardroom, how frequently the professional accesses the web application (e.g., logs in), number of users whom the professional has referred to the web application, number of recommendations and/or referrals received by the professional, how many articles or blogs the professional has emailed or re-tweeted, whether the professional has signed up for a newsletter, whether the professional is following social media profiles of the web application, recommendations or referrals that the professional has provided, how involved the professional is in various communities of the online community, how many events to which the professional has RSVP'ed, how many users the professional has referred to events, number of tweets about events, the professional's account status (e.g., up-to-date on payments, no past due balances, etc.), amount of traffic to the professional's profile page, how long the professional has been registered with the application (e.g., whether the professional registered in the first year or was a charter member), and/or tax ambassador designation (e.g., tax ambassadors are professionals who advocate for the web application).

In an embodiment, professional members may be segregated into one or more weighting tiers based on their participation or activities in the online community. Professional members with higher participation rates may be assigned to higher tiers and receive higher weighting in user searches and/or search results, whereas professional members with lower participation rates may be assigned to lower tiers and receive lower weighting in user searches and/or search results. It should be understood that professional members may be assigned to tiers based on thresholds. For example, professional members with a weighting or score greater than a first threshold may be assigned to a first tier, professional members with a weighting or score greater than a second threshold may be assigned to a second tier, and so on.

By way of illustration, professional members may be grouped into three tiers: Tier 1, Tier 2, and Tier 3. Tier 1 may comprise the most active professional members, who, by virtue of being in Tier 1, may receive a sixty percent (60%) additional weighting (e.g., a weighting coefficient of 1.6) within search algorithm(s). Tier 2 may comprise less active professional members, who may receive a thirty percent (30%) additional weighting (e.g., a weighting coefficient of 1.3) in user searches or search results. Tier 3 may comprise less active professional members than Tier 2, each of whom may receive a ten percent (10%) additional weighting (e.g., a weighting coefficient of 1.1) in user searches or search results. There may also be a set of professional members who are even less active than Tier 3 members, and who receive no weighting in user searches or search results (e.g., a weighting coefficient of 1.0).

Tier 1 may comprise those professional members who have become an expert panel member, have achieved a tax ambassador designation (i.e., indicating that the member is an advocate of the web application), registered in the first year of the web application or are charter members, have achieved a certain level of traffic to their user profiles, have completed their entire profile (i.e., filled out all information), have maintained registration and up-to-date account status with the web application for a certain length of time without interruption (e.g., made all of their payments, no account suspensions, etc.), and have authored a blog for the web application. Tier 2 may comprise those professional members who do not meet the qualifications for Tier 1, but who have participated in one or more tax forums (in terms of asking and/or answering questions), have commented on one or more blogs, have received a certain number of recommendations on their profile, have referred a certain number of new members to register with the web application, have achieved a certain number of tax connections, have been involved in one or more tax communities, and have spent a certain amount of total time signed in to the web application. Tier 3 may comprise those professional members who do not meet the qualifications for Tier 2, but who have RSVP'ed to an event, have emailed or re-tweeted an article or blog, have signed up for a newsletter through the web application, have followed the web application through social media, have referred or tweeted friends to tax events, have reported that they were in a meeting, have submitted a video or picture, and have listed a tax conference.

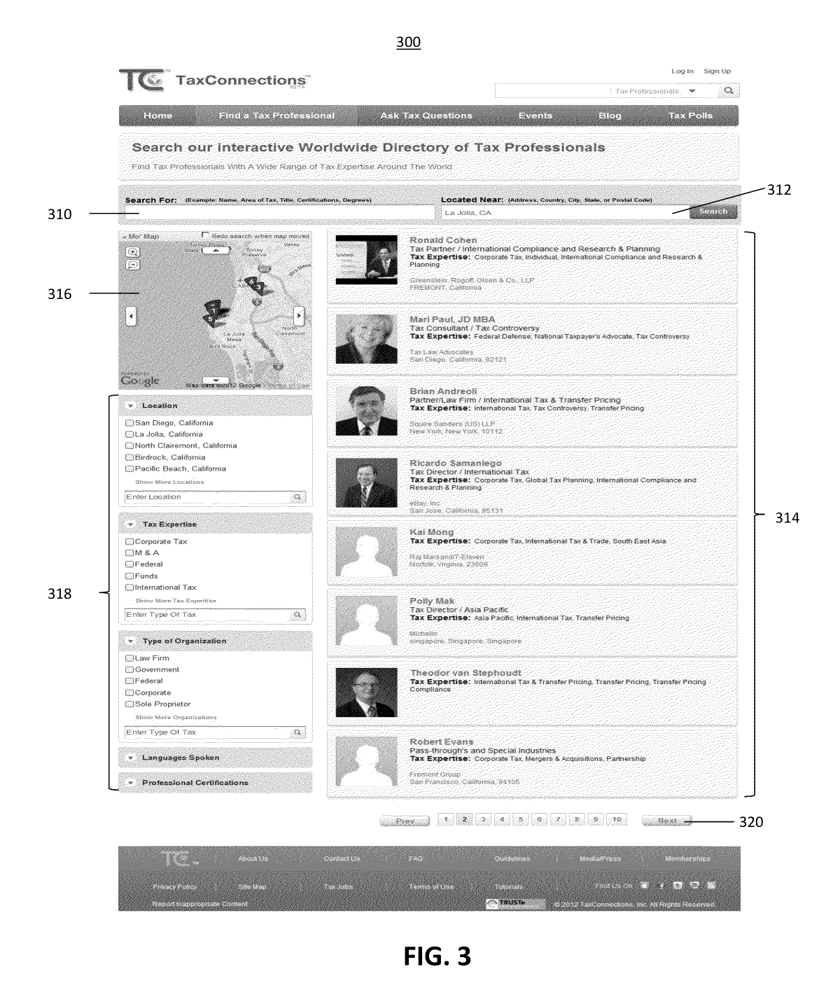

FIG. 3 illustrates an example search user interface 300 of the web application, according to an embodiment. Search user interface 300 may comprise a search box 310, into which a user may input search terms. One or more other search boxes 312 may also be provided, into which a user may input additional search terms, such as a location for tax professionals (e.g., city and state, postal code, etc.). Search user interface 300 may also comprise search results 314, listing one or more professional members satisfying inputted search criteria. The number of professional members displayed may be limited to a predetermined number (e.g., eight in the illustrated example), and pagination 320 at the bottom of search user interface 300 may allow a user to view additional lists of professional members who have satisfied the inputted search criteria. The locations (e.g., place of business or residence) of the listed professional members (e.g., just those professional members being displayed in search user interface 300 at any given time) may be displayed on a virtual map 316 using one or more icons or other indications. In addition search user interface 300 may comprise one or more filters 318, which allow a user to filter the results based on additional criteria, such as location, expertise, organization type, spoken languages, and/or professional certifications. Each filter may be expandable and collapsible. In addition, for each filter, a set of one or more selectable values may be listed. These selectable values may be derived from the attributes possessed by the professional members in the original or subsequent search results. Each filter may initially list a predetermined number (e.g., five in this example) of possible values, and provide a link or other input for displaying more possible values. Each filter may also comprise an input box for entering user-defined values for refining the search results.

5. Questions Module

In an embodiment, the web application comprises a questions module. This module may comprise one or more user interfaces via which a user can get information and advice on any number of tax questions they might have (e.g., income tax, banking laws, international regulations, tax legislation, etc.). In one embodiment, the question module may comprise at least three user interfaces: (a) a search interface for searching for tax questions and answers, (b) a discussion interface for reading, discussing, and clarifying more about a particular tax question or answer, and (c) a question interface for submitting a tax question to the worldwide tax community.

The search interface may comprise a search-results frame which lists one or more tax questions that have been submitted, and a search frame providing inputs for searching available tax questions. In the search frame, one or more inputs may be provided which allow a user to enter keywords to search for tax questions (e.g., that other users have previously asked), or further refine already-found search results through one or more filters. For example, the search interface may comprise location, status, and topic filters. The location filter refines search results based on what country the tax question was asked about. The status filter allows users to choose to limit the search results to only those questions which have been answered or only those questions which have not been answered. The topic filter allows users to limit the search results to a particular topic. In an embodiment, tax topics are crowd-sourced tags that specify what areas a particular tax question belongs in. Thus, the list of topics may grow as more questions are submitted using the questions module. The filter criteria that are selected by the user determine what tax questions are displayed in the search result frame of the search interface.

In an embodiment, the search results frame of the search user interface lists each question returned in the search results in a separate record. Each record may contain the tax question as well as some additional information, including an identification of who asked the question (e.g., name, profile image, etc.), whether or not the question has been answered, a brief snippet of the answer (if answered), the topics that have been associated with the question (i.e., the topics with which the question has been tagged), number of comments, etc. In addition, a user may be able to view a pop-up of which tax professional(s) answered a particular question, as well as click on the question itself (and/or a “comments” link associated with the question) to view the question and all associated answers, comments, and/or clarifications. If a question remains unanswered and/or the user viewing the question is a tax professional member, a link may direct the user to answer the question or, if the user is not logged in, direct the user to a registration or login page.

In an embodiment, answers can be ranked and rated according to their usefulness. Users and tax professionals may be given the ability to rate how well a question was answered using one or more inputs (e.g., a “like” button and/or “dislike” button, selection of a numerical rank from one to five or one to ten, etc.). In addition, answers from tax professional members can be automatically and initially weighted higher by the web application than answers by a free member. In addition, users may be given the ability to flag questions and/or answers that are inappropriate in any way. If enough users flag a question and/or answer, it may be removed. As discussed elsewhere herein, these ratings may be used to weight search results for professional members (e.g., by the professionals-search module). For example, if a professional member consistently receives high ratings for his or her answers, that professional member may benefit from a higher weighting coefficient or tier in other users' search results. Conversely, if a professional member consistently receives lower ratings for his or her answers, that professional member's weighting coefficient or tier may be reduced, or the member may not even be considered for search results (e.g., a weighting coefficient of zero).

One or more user interfaces of the questions module may also comprise a leading-professionals frame, which may list one or more leading or featured tax professional members, as determined by an algorithm and/or predefined criteria. For instance, the leading tax professional members may comprise those tax professionals who have answered the most tax questions. The ratings of the members' answers may also be considered in determining which members should be listed in this frame. In an embodiment, the listing of the professional members may include, for each member, a profile image, name, title, expertise, location (e.g., city, state, country), etc.

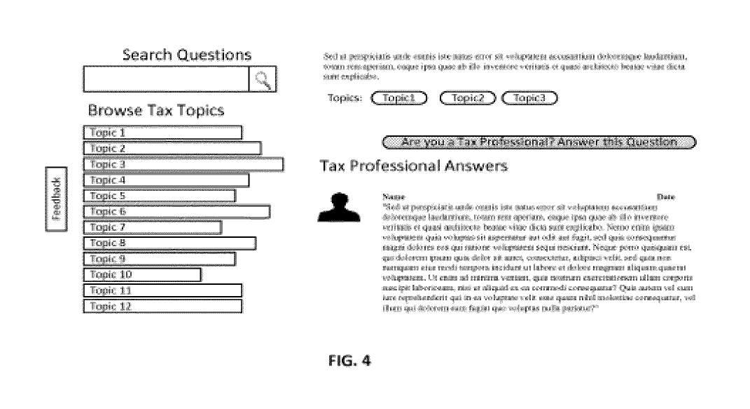

In an embodiment, if a user clicks on a tax question (e.g., in the search results frame), the user is directed to a question-details user interface comprising all of the information associated with a particular question. An example of the question-details user interface is illustrated in FIG. 4. This user interface may retain the search frame and the leading-professionals frame, and have a primary frame devoted to the selected tax question. A question portion (e.g., top portion) of this primary frame may comprise the question itself along with any description that the asker included with the question. The topics associated with the question may also be listed, along with how many times the tax question was asked, and when and from where the tax question was asked. If the asker has provided any question or any respondents have requested clarification about the question itself, that information may be included with the question portion of the frame.

In an embodiment, immediately below the question portion of the primary frame of the question-details interface may be a button prompting the user to answer the question if they are a tax professional and can answer the question. If the user clicks the button but is not logged in, they may be redirected to a login page. If they are logged in as a free member, they may be redirected to a tax professional sign-up page. If they are logged in as a tax professional, a form field and button may appear for them to provide an answer. However, in an embodiment, if they have already answered the question, they are not allowed to leave another answer (but may still be permitted to comment on other members' answers).

In an embodiment, below the question portion and the answer section of the primary frame of the question-details interface is a listing of all answers that have been submitted for the selected question, as well as any comments on those answers. This listing may take a consistent form, e.g., the answering member's profile image and name followed by the answer that the member submitted. If the user is logged in and has answered the question, they may be given the option of editing or deleting his or her answer. Other tax professional members may have the option to leave a comment on an answer, flag an answer as inappropriate, mark an answer as “useful” to help the system determine what the “best” answer is (e.g., using one or more algorithms), rate the answer, or otherwise provide feedback about the answer. The questions module may determine the “best” answer based on users' feedback, and display that “best” answer first. In an embodiment, the questions module may rank all of the answers based on users' feedback and order them with the highest-ranked answer displayed first and the lowest-ranked answer displayed last.

The questions module may also comprise a user interface for asking a new tax question. An input (e.g., link or button) may be visible in the header of every user interface related to the questions module (including user interfaces provided by other modules), which directs a user to an ask-question interface for submitting a question (if logged in) or a login interface (if not logged in). The user interface may comprise a form, comprising inputs into which the user may enter the country and state or province of their location, the question itself (which may be limited to a predefined number of characters with a dynamic display of remaining characters), and/or further details to help potential answerers of the question. The ask-questions user interface may also comprise inputs into which the user may enter, or via which the user may select, one or more topics (e.g., at least one and up to six) to be associated with the question. These topics may be selected from a list of crowd-sourced topics via a pop-up window. In addition, the user may click a checkbox to agree to a Terms of Use agreement, privacy policy, and/or forum guidelines (which may all be conveniently linked), and then submit the tax question to be answered by the interactive worldwide directory of tax professionals supported by the web application.

6. Events Module

In an embodiment, the web application comprises an events module. The events module may provide an events calendar that allows all tax professionals and associations worldwide to list their events, conferences, seminars, webinars, and any continuing education training and social gatherings for tax professionals in one online resource directory. Every tax association currently faces the challenge of effectively marketing their offered conferences and continuing education classes to tax professionals. In addition, every tax professional currently faces the challenge of having to search through many different tax association websites to locate the right tax training course required for their continuing education requirements. By providing a single online directory for all tax events, tax professionals who are visiting a city (e.g., for business or personal reasons) can immediately know what tax courses are available to them in that city. Also, the events calendar may create better cross-training between tax professionals in participating countries. The events calendar can also be used as a sales and marketing tool to attract tax professionals to the web application.

In an embodiment, the events module may comprise a searchable (e.g., by location, topic, keyword, organization, event type, date range, etc.) events user interface that displays a list or grid of tax events (e.g., meeting the one or more search criteria). For example, the interface may comprise a list of five to ten tax events displayed in time-descending order. At the bottom of the interface, there may be a button that indicates “More Tax Events.” If the user clicks on the button, he or she may be shown a list of all tax events in the location for which the user is searching. In addition, the events user interface may comprise a search frame with a search box which receives keywords and one or more filter criteria for refining a search, e.g., by location, organization, event type, date and/or date range, etc. For instance, the search frame may allow a user to select a date range that will display only those events that are within the specified date range. A drop-down and/or clickable calendar may also be provided for selecting a month, day, and/or year as search criteria. Results based on date may include dates within a day or two or a week of the selected date or date range.

Each tax event may be listed with the name of the tax event, location of the tax event, date of the tax event, a brief summary of the tax event, and/or an image (e.g., logo) uploaded by the organization (e.g., tax association) or other entity sponsoring the tax event. If a user selects a tax event (e.g., by clicking on the name of the event or the tax association logo associated with the event), the user may be shown an event-details user interface that provides the user with all of the information about the selected event.

In an embodiment, an organization (e.g., tax association) may pay to be a “Featured Tax Event.” Featured tax events may be displayed in a sponsored frame of one or more of the user interfaces of the website (e.g., the events user interface).

In an embodiment, the events module may also provide a searchable archive of tax events. This can be used for search engine optimization (SEO). One or more user interfaces of the events module may comprise a reference (e.g., hyperlink) to a tax events archive user interface, which will comprise all past events within a set or specified time frame. Inputs (e.g., a drop-down for day/month/year with a mini-calendar pop-out, when the drop-down is clicked, for selecting a date) may be provided to change the time frame (e.g., a start date and end date). The tax events archive user interface can be formatted the same way as the events user interface, but will display events from previous months or years with a feature that states “Previous Events.” All of the events may populate by month and year. In addition, all events may automatically change to events that happened in the selected month and year in a click-ordered chronology, and all of the months and years may drop down, giving the user the ability to select any month and year.

In an embodiment, the events module comprises a post-an-event user interface for posting a tax event to the events module. According to an embodiment, only professional members or other non-free members (e.g., employers or other organizations) may post a tax event. For example, a pop-up may be provided that states that you must be a tax professional (or other type of user) to list any events. If a user is logged in as a professional member, then he or she may post a tax event by filling out inputs in the post-an-event user interface with event information. This information will be used to generate an event-details user interface for the posted event, which may be viewed by other users. The post-an-event user interface may collect event information, including, without limitation, event type, event title, organization name, organization URL, registration page URL, event logo/image, event location (e.g., address, state, province, country, city, postal code, etc.), date(s) and/or time(s) (e.g., start date/time, end date/time, time zone, etc.), event topic(s), event description, information about event speaker(s) (e.g., name, title, company, image, biographical information, etc.), information about event contact(s) (e.g., name, email address, phone number), continuing professional education credits available, registration fee, etc. The post-an-event user interface may also perform form validation to ensure appropriate inputs, and may require the user to agree to terms of use and/or a privacy policy before submitting the event.

A user who has submitted a tax event may be granted access to a landing page for the tax event. The landing page may be a user interface for all events posted by the user, and allows the user to manage communications with tax professionals who have registered for the event or otherwise indicated that they will attend the event. The events landing page may also comprise tools that allow the user to edit or delete event information. Other user interfaces provided by the web application to the user may provide a link (e.g., as a selection in a navigation drop-down of a header) to this events landing page, as well as a link to the post-an-event user interface.

The web application may generate an event-details user interface for each event that provides details regarding the event. For example, the event-details user interface may comprise all or a portion of the information entered for the event using the post-an-event user interface. In addition, the event-details user interface may comprise one or more of the following:
(a) A link (e.g., hyperlink containing a Uniform Resource Locator (URL) to an external or internal resource) for registering for the event. The link may be to an external website (e.g., of the organization that is sponsoring the event).
(b) One or more inputs for inviting one or more other users to the event. For instance, the input may comprise a text box for entering one or more email addresses, to which the web application will send an invitation. In an embodiment, the inputs may also allow the user to send an invitation to everyone in his or her tax community (e.g., all professional contacts through the web application).
(c) One or more inputs (e.g., a button marked “I Will Be Attending”) for RSVP'ing to the event, if the user is logged in as a professional member.
(d) An attendance list or link to an attendance list, which allows a user to see who is attending the event.
(e) Map and/or directions to the event. For example, the event-details user interface may interface with Google Maps™ to provide an indication of the location of the event overlaid on or integral to a virtual map of the area surrounding the event location.
(f) Comment section for discussing the tax event. The comments section may be similar in structure to the question-details user interface, described elsewhere herein. For instance, the comment section may comprise a list of comments, comments to comments, etc. and may include the ability to provide feedback about a comment, a comment to a comment, etc. (e.g., using “like” and/or “dislike” buttons, flagging the comment as inappropriate, etc.).

In an embodiment, when a user (e.g., professional member) posts a tax event through the web application, a confirmation email may be sent to the user to confirm that the event was submitted. In addition, an email or alert may be sent to the user who submitted the event whenever a professional member confirms his or her attendance, and/or whenever someone has submitted a comment about the event. The events module may also perform analytics on how many users viewed the event, how many users registered for the event, how many users commented on the event, etc., and supply those analytics in an email or other interface to the user who submitted the event. In an embodiment, the events module may also send emails or alerts to tax professional members concerning tax events that have been submitted, based on geographical location, tax topics involved, tax organization sponsoring the event, type of event, etc.

7. Blog Module

In an embodiment, the web application comprises a blog module, which enables the display and/or management of global and/or local blogs by the web application. The blog module may comprise one or more user interfaces, such as a blog-list user interface, and a blog-details user interface.

The blog-list user interface may list one or more blog entries. For instance, the blog-list user interface may comprise a standard two-column layout, with posted blog entries listed in one column (e.g., with the most recent entry on top) and with blog navigation and/or search features (e.g., category filters, links to archives, etc.) in the other column. It should be understood that the listed blog entries may actually only comprise a portion or preview of the blog entry, and may be displayed with other relevant information (e.g., name of user who posted the blog entry, time that the blog entry was posted, topic tags, etc.).

In an embodiment, the blog-list user interface may be a mash-up which aggregates blog entries from multiple external sources. Alternatively or additionally, the blog-list user interface may list blog entries which are hosted by the web application. For instance, the web application may provide one or more user interfaces which allow users (e.g., professional members) to maintain and manage their own tax blogs. A blog dashboard may be provided by the web application. The blog dashboard may be linked to through the navigation drop-down in the header provided to professional members. In an embodiment, the blog dashboard allows a professional member to establish a blog category, input or edit a blog-roll (e.g., a list of other blogs that the blogger recommends), preview, post, edit, and publish a blog entry, and view prior blog entry posts and/or archives. The blog dashboard may also display analytics about the professional member's blog, such as the number of views, how long users are viewing blog entries, the city, state, and country of readers of the blog entries, etc.

In addition, professional members who have established a blog may be given a tax blogger tag on their user profile interfaces, which may be visible and searchable by other users. Professional members who are bloggers may also be provided a link (e.g., hyperlink) on their profile page, which directs users to a list of their blog entries.

The blog-list user interface may be searchable. For example, the interface may comprise a search frame with one or more inputs via which a user can search blog entries by keyword, topic, location, etc. In this manner, a user may be able to refine the search by keyword on any topic of interest written about by a tax blogger. Users may also be able to refine the search by country or other location. This can be advantageous since tax rules and regulations generally differ among countries.

If a user clicks on a blog entry listed in the blog-list user interface, the user may be directed to a blog-details user interface for the selected blog entry. The blog-details user interface provides the entire blog entry (or a portion of the blog entry if the entry is long enough to make pagination required or desirable), along with relevant information, such as the name of the user who posted the blog, time that the blog entry was posted, topic tags, etc. The blog-details user interface may also provide one or more inputs for users to input comments on the blog entry. In addition, if the user is a blog administrator (e.g., the user who posted the blog entry), the blog-details user interface may also comprise one or more inputs for editing the blog entry.

The blog module or other module of the web application may analyze the blogs of users to determine the top tax bloggers. In an embodiment, top tax bloggers may be determined to be those bloggers who have been voted as the best by users of the web application. Blogs can be ranked by the number of views of their content and/or other feedback from readers. Top tax bloggers may be provided a badge (e.g., icon) or other indication that can be prominently displayed on the professional member's profile interface and viewed by users. Top tax bloggers may also benefit from a higher weighting coefficient or tier in other users' search results.

In an embodiment, a user interface is provided for viewing a blog. For example, a user can utilize the user interface to view a worldwide tax blog, another user's tax blog, and/or his or her own tax blog. The user interface provides a list of tax blog entries, wherein each listed entry may provide a snippet or excerpt of the full entry, and provide an input (e.g., link) for viewing the entire entry. The user interface may also comprise one or more search inputs for filtering the blog entries by keyword and/or topic. If a user clicks on a blog entry in a list of blog entries, the user may be provided a user interface for viewing the entire blog entry, along with any details, comments, etc. For members maintaining their own blogs, an input may also be provided for posting a new blog entry.

In an embodiment, a user interface is provided for viewing a tax blog entry. The user interface may comprise the title of the entry, author of the entry, time that the entry was posted, one or more topics associated with the entry, input (e.g., icon) for flagging the entry (e.g., for inappropriate content), one or more inputs (e.g., icons) for sharing the entry on one or more social networks (e.g., Facebook™, Twitter™, etc.) and/or by email, the content of the entry, one or more images (e.g., related to the content of the entry), and/or one or more discussions about the entry (e.g., comments on the entry, comments on comments, comments on comments on comments, etc.).

In an embodiment, any professional member may be permitted to create a blog through the web application. The blog may be hosted by the web application or an external application (e.g., interfaced with the web application via one or more APIs). A user interface may be provided for creating a new tax blog. The user interface may comprise inputs for entering a blog title and/or a description for the blog. The user interface may also require the member to agree to a terms of use for the blog before submitting the blog for creation. In embodiments which permit externally hosted blogs, the user interface may also comprise an input for specifying a URL of the blog. The member may then submit the blog for creation, for example, by posting the inputted information to the web application for creation of the blog.

Once the blog has been created, the professional member may add entries to his or her blog. Accordingly, a user interface may be provided for submitting a new blog entry. The user interface may comprise inputs for entering a blog title, blog content, adding an image, adding a video (e.g., by uploading the video and/or entering a URL of the video), entering one or more topics to be associated with the entry, confirming agreement with a terms of use and/or forum guidelines, saving the entry as a draft, previewing the entry, and/or publishing the entry so that it may be viewed by other users.

In an embodiment, a user interface is provided through which a member can manage his or her blog. The user interface may comprise a list of the member's submitted blog entries, along with inputs for viewing individual blog entries, editing individual blog entries, and/or deleting individual blog entries. A similar user interface may be provided for managing the user's draft blog entries, i.e., those blog entries which the member has not yet published.

In an embodiment, a user interface is provided for viewing statistics or analytics for a blog. The user interface may list each of the member's submitted blog entries (e.g., by title) in association with one or more statistics for that entry. Such statistics may include, without limitation, the number of views of the entry, the number of comments posted for the entry, and the number of clicks to the member's profile page that the entry generated.

In an embodiment, a worldwide tax blog and/or one or more regional tax blogs may be provided. These tax blog(s) may comprise a mash-up of blog entries published by a plurality of professional members and/or the operator of the web application. The blog(s) may also comprise search inputs for defining search criteria, such as keywords, topics, location (e.g., country). Each blog may also comprise inputs for browsing available blog topics, view news regarding the web application, and the like. In addition, the blog(s) may comprise a list of a predetermined number (e.g., 5, 10, etc.) of the top bloggers (e.g., as determined by number of views, entries, comments, etc.) and/or an input for viewing a top predetermined number (e.g., 10, 50, etc.) of tax blogs. If a user selects the input for viewing the top tax blogs, he or she may be directed to a user interface listing the top tax blogs.

8. Polls Module

In an embodiment, the web application comprises a polls module, which allows polls or surveys of users to be taken. Tax polls provide a simple, interactive solution for allowing users to express their opinions on subjective tax matters. For example, the polls module may receive and display a question on one or more user interfaces of the web application (e.g., the home page, as a question on a user interface of the questions module, etc.). Users can read the question, select an answer from a list of options (e.g., by selecting one or more of a plurality of radio buttons or checkboxes), and click a voting input (e.g., button) to record their votes. Each vote may be recorded in association with an Internet Protocol (IP) address or member identifier and only one vote may be allowed per IP address or member identifier in order to prevent users from voting more than once for a particular tax poll. Once a user votes, the list of options may be replaced with a bar graph that displays a bar for each option that represents the number of users who have voted for that option or another indication of the number and/or percentage of users who have voted for each option. In an embodiment, an input (e.g., hyperlink) may be provided which allows users to view results for past tax polls, as well as a list of recent tax polls, the date and/or time they were posted, and/or how many views they received. During creation of a poll, the creating user may specify an expiration time or time duration for the poll. Once the expiration time is reached or the time duration ends, the poll may be closed to further voting. Thus, only an indication of the voting results may be displayed (e.g., in place of the list of options).

In an embodiment, once a new poll is created by a user (e.g., a professional member), the tax poll may be presented to or made available to one or more other users through a poll user interface. The poll user interface may provide information regarding the poll, such as media (e.g., image(s), video(s), text, audio, etc.) and/or a question, and two or more selectable options. The poll user interface may also provide indications of how other users have voted (e.g., by displaying a number or percentage of selections for each of the selectable options). The poll user interface may also comprise inputs for entering and submitting comments, as well as a list of comments that other users have submitted. In addition, the poll user interface may comprise a list with links to other polls (e.g., a list of the five or ten most popular polls).

An example tax poll user interface may comprise an embedded video or description about a new proposed tax, and the question “What is Your Opinion on this Tax?”. In addition, the user interface may provide three selectable options: “Like”, “Dislike”, and “No Opinion.” It should be understood that if the poll has expired or been closed, these options may no longer be selectable. In addition, an indication of voting results for each option may be displayed. For example, the user interface may indicate how many votes were cast for each option and/or percentage of votes cast for each option.

9. Registration Module

In an embodiment, the web application comprises a registration module for registering users with the web application. Specifically, the registration module allows visitors to register with the web application to become a member by creating a user account 112 and/or user profile 114. The visitor may register as a free or non-professional member or a professional member. For instance, the web application may comprise a sign-up user interface that provides one or more inputs for selecting either a free member account or a professional member account. The free or non-professional member account may be free of charge, whereas the professional member account may require a subscription fee, such as a monthly subscription fee. In addition, the free or non-professional member account may have access to fewer or different resources than the professional member account. Thus, the user account 112 and/or user profile 114 may comprise different data depending on whether the member is registered as a professional or free/non-professional member.

Once registered, a member may log in to platform 110 to access the functionality of the web application. For example, a free member seeking a professional may log in to his or her user account 112, using a username and password, supplied during registration, and interact with registered professionals, review information, post questions, and the like. A free member may interact with a professional member by asking questions. In an embodiment, the web application may comprise a public message board, through which a free member can post a question and any professional member can post a response. Professional members can also be allowed to post questions, information, answers to hypotheticals, and the like.

In an embodiment, the registration module may comprise a first set of one or more user interfaces, which allow a user to provide basic sign-up information, such as a username and password. This set of user interfaces may be identical or similar for professional and non-professional members. In addition, during registration of a non-professional and/or professional member, the registration module may also require the user to validate their newly acquired account access.

However, when registration is of a professional member, the registration module may provide an additional or different set of one or more user interfaces than during registration of a non-professional member. This set of user interfaces may comprise one or more sections. Examples of user interfaces that may be used for registration of a tax professional will now be discussed. In an illustrative example, the set of user interfaces may be divided into at least ten sections: contact information, social media presence, professional experience, employment, law societies, associations, education, achievements, professional interests, and activities/hobbies. The sections may be presented on a single web page or distributed across a plurality of web pages (e.g., with each section on a separate web page or with two or more sections sharing a web page). Professional users may be instructed to fill out the form as thoroughly as they can, as the supplied information will be used to populate their user profile. As the professional user goes through the section, entering information, they may be given the options to save the inputted information, save the inputted information and continue inputting information, and after completion of the first section, to return to a previous section.

A contact-information section may comprise inputs which allow a professional user to input basic contact information. The contact information may include, without limitation, a salutation, first name, middle name, last name, last name suffix, home address, country, state/province, city, postal code, language(s) spoken (e.g., using a drop-down or text selection area), date of birth, personal email, mobile phone number, business email, and/or business phone number.

A social-media-presence section may comprise inputs which allow a professional user to upload a photograph, résumé, and share his or her social sites. For example, a file selection input (e.g., “browse” button) may be provided for uploading an image (i.e., a profile image), and another file selection input may be provided for uploading a résumé (e.g., as a Microsoft Word™ document or in Portable Document Format (PDF)). The social-media-presence section may also comprise text boxes for entering a company website address, Skype™ user identifier, blog title, blog URL, YouTube™ video, LinkedIn™ profile URL, Facebook™ profile URL, and/or Twitter™ page URL.

A professional-experience section may comprise inputs which allow a professional user to provide his or her primary area(s) of technical strength/expertise. For instance, drop-down menus may be provided, which allow the user to select one or more (e.g., three) areas of primary technical strength from a plurality of available areas. In addition, the professional-experience section may comprise a text box or text area into which a professional user may enter a professional summary. Each tax professional may be encouraged to spend time filling out this area properly in order to promote his or her tax expertise to the widest audience available.

An employment section may comprise inputs which allow a professional user to enter his or her recent employment. In addition, an input may be provided which allows a professional user to add additional employment sections for entering additional employment information. In an embodiment, the number of additional employment information may be limited. For example, a professional user may be allowed to add as many as fifteen previous employers. Each employment section may comprise inputs (e.g., text box, text area, etc.) for a user to enter and/or select a type of organization, tax title, tax expertise, recent employer name, year that employment at the employer began, year that the employment at the employer ended, location (e.g., country, state, city, postal code), industry, company revenues/sales, and/or a job description.

A law-societies section may comprise inputs which allow a professional user to input one or more law societies of which he or she may be a member. The law-societies section may be geared towards users in countries outside the United States, and may comprise two side-by-side list menus. A user may select a law society or societies from the list on the left side, and click an input (e.g., right arrow icon) to add the selected law society or societies to the list on the right side. Conversely, a user may select a law society or societies from the list on the right side, and click an input (e.g., left arrow icon) to remove the selected law society or societies from the list on the right side. The law societies in the list on the right side will be associated with the user when he or she saves the inputted information.

An associations section may comprise inputs which allow a professional user to input one or more associations of which he or she may be a member. The associations section may be similar or identical to the law-societies section in format, except that instead of the user moving law societies from one list menu to another list menu, he or she may move associations from one list menu (e.g., a left side list menu) to a second list menu (e.g., a right side list menu), and vice versa.

An education section may comprise inputs which allow a professional user to enter educational details (e.g., university attended). In addition, an input may be provided which allows a professional user to add additional educational sections to enter additional educational information. In an embodiment, the number of additional educational information may be limited (e.g., up to fifteen additional universities). Each educational section may comprise inputs (e.g., text box, text area, drop-down menus, etc.) for a user to enter and/or select the name of a university, class year, type of degree earned, major, location (e.g., country, state, city), and/or comments.

An achievements section may comprise inputs which allow a professional user to input or select certifications and achievements. In an embodiment, the achievements section comprises multiple sub-sections for each of a variety of possible types of certification or achievement. For example, sub-sections may be provided for entering one or more areas (e.g., states, provinces, countries, etc.) in which the user is a certified public account, one or more areas in which the user is a chartered accountant, one or more areas in which the user has bar admission, and one or more areas in which the user has international bar admission. Each sub-section may provide five drop-down menus for selecting five different areas in which the user is licensed, admitted, etc. In addition, an input may be provided which allows a user to add additional drop-down menus for additional area selections (e.g., up to fifteen total areas per sub-section). The achievements section may also comprise a sub-section which allows a professional user to select additional certifications and/or professional designations, and a sub-section which allows a professional user to select courts to which he or she is admitted. These sub-sections may comprise the same dual menu list format as described above with respect to the law-societies section, which allows a user to move selections from a first list (e.g., left list) to a second list (e.g., right list), and/or vice versa, using one or more inputs (e.g., arrow icons). Those selections in the second list will be associated with the professional user when he or she saves the inputted information. Examples of additional certifications or professional designations include, without limitation, certified financial manager, certified financial planner, certified fraud examiner, certified fund specialist, etc.

A professional-interests section may comprise inputs which allow a professional user to select one or more areas about which they would like to receive alerts. For example, the professional-interests section may comprise a plurality of checkboxes, with each checkbox associated with one of a plurality of professional interests. A user may select the checkbox for each professional interest about which he or she wants to receive alerts, notifications, or other information from the web application. There may also be inputs for entering and selecting one or more other professional interests. Examples of professional interests include, without limitation, building tax professional brand, business development, contract/consulting projects, tax internships, building tax network, tax communities, tax professional connections, conference speaker, tax events, tax webinars, search services, tax blogger/writer, tax expert panelist, tax salary surveys, job opportunities, tax professor/instructor, generating new clients, mergers and acquisitions tax practice, and/or technical tax help.

An activities/hobbies section may comprise inputs which allow a professional user to input or discuss his or personal interests. These interests may be displayed on the professional user's tax boardroom interface. For example, the activities/hobbies section may comprise five text box inputs, which may be expanded up to fifteen text box inputs.

Once a professional user has finished with all of the sections, he or she may click on an input (e.g., “finish” button) which completes the registration process.

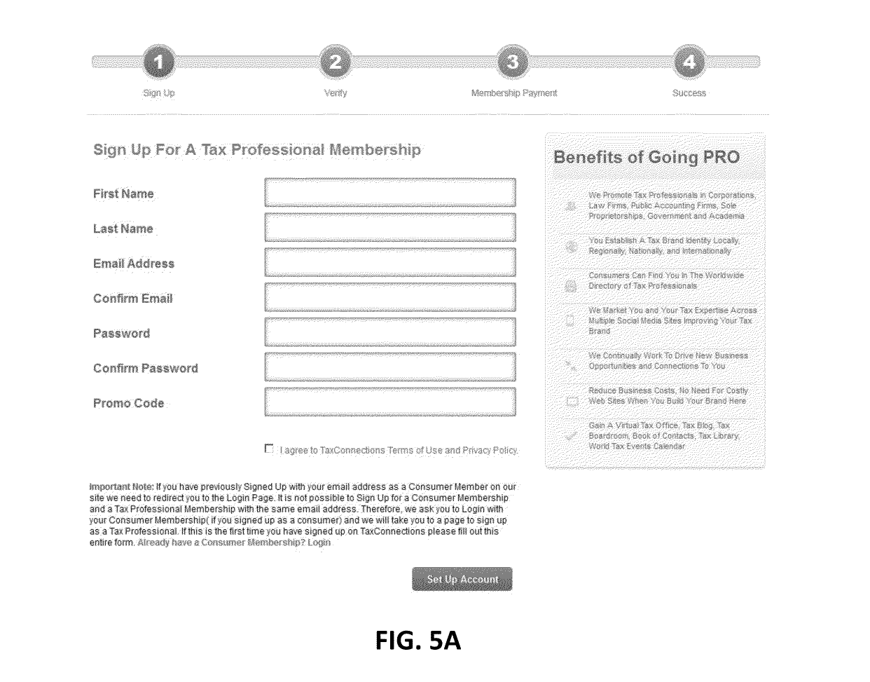

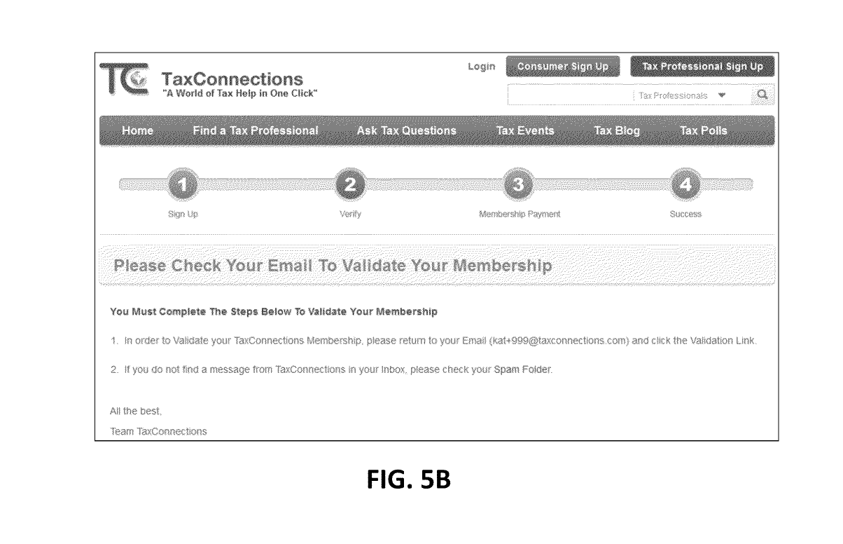

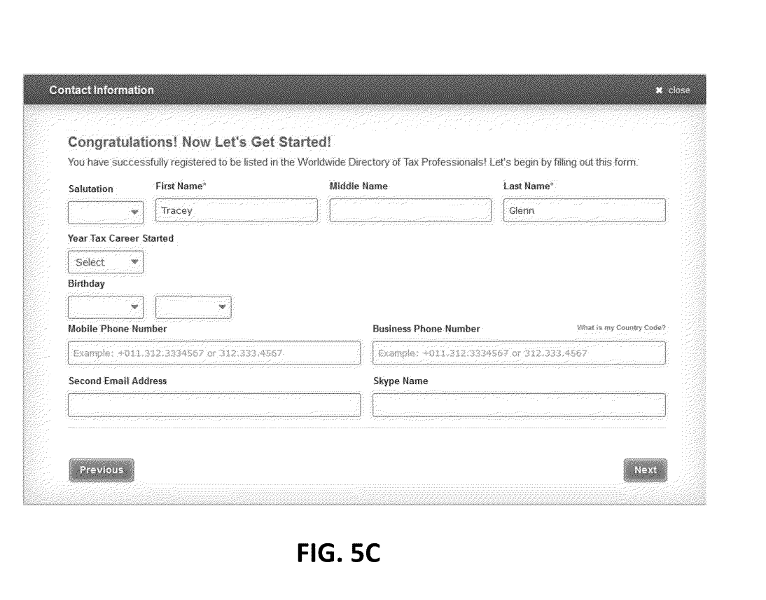

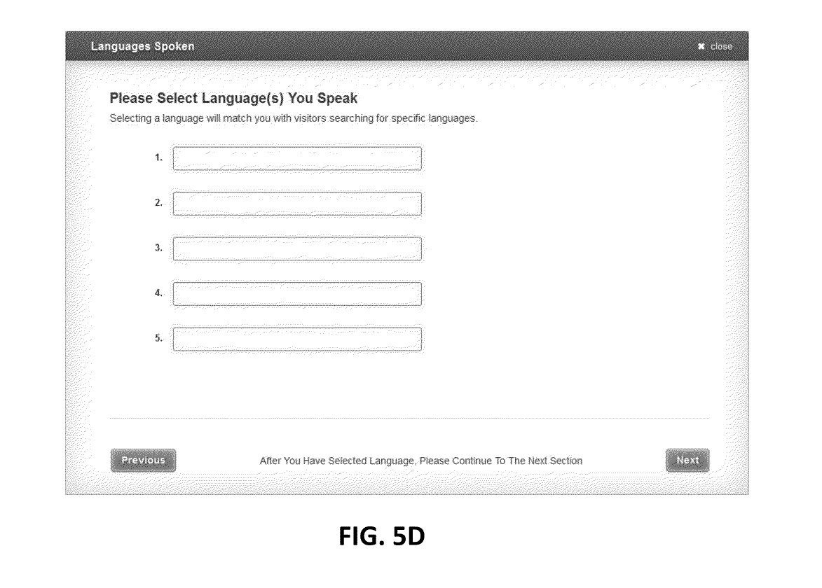

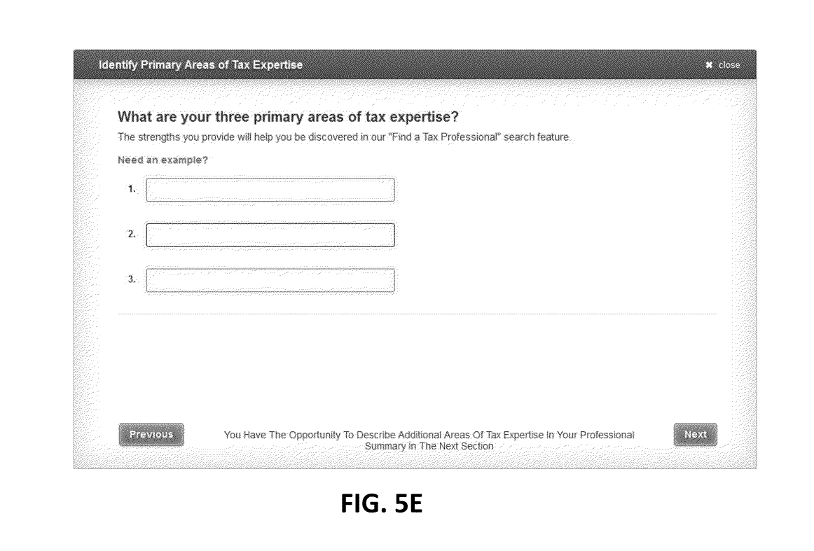

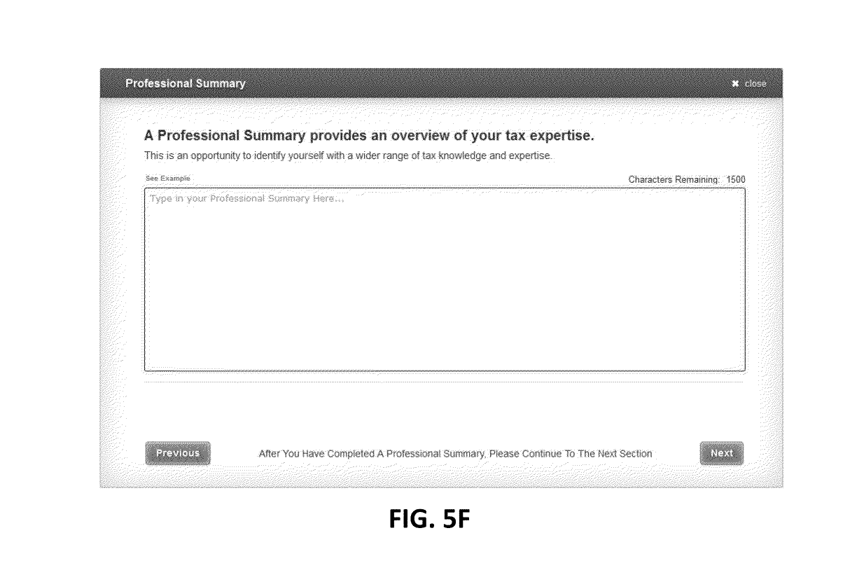

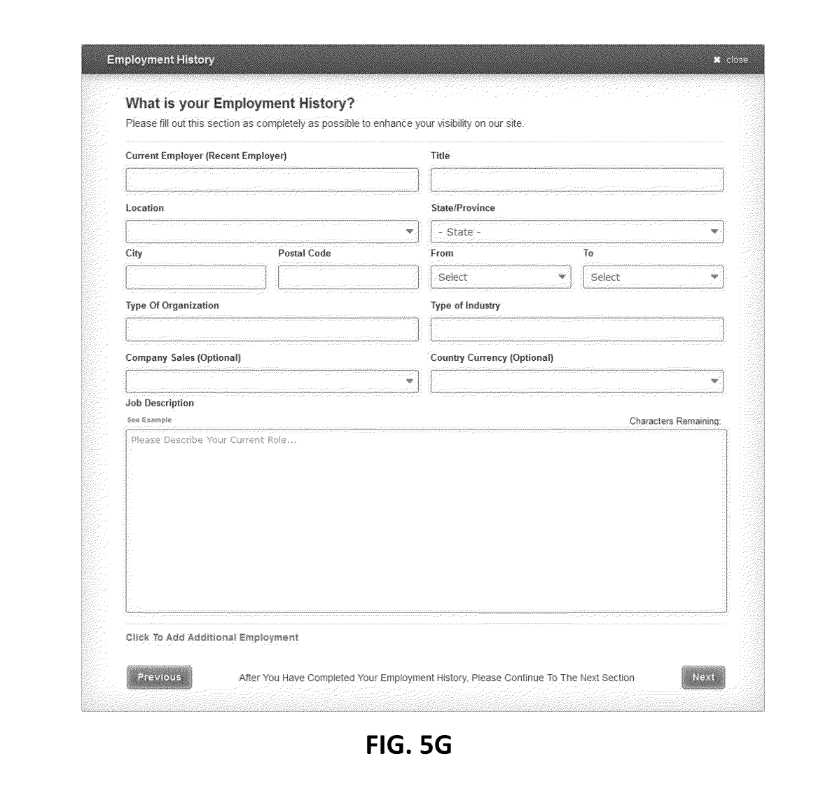

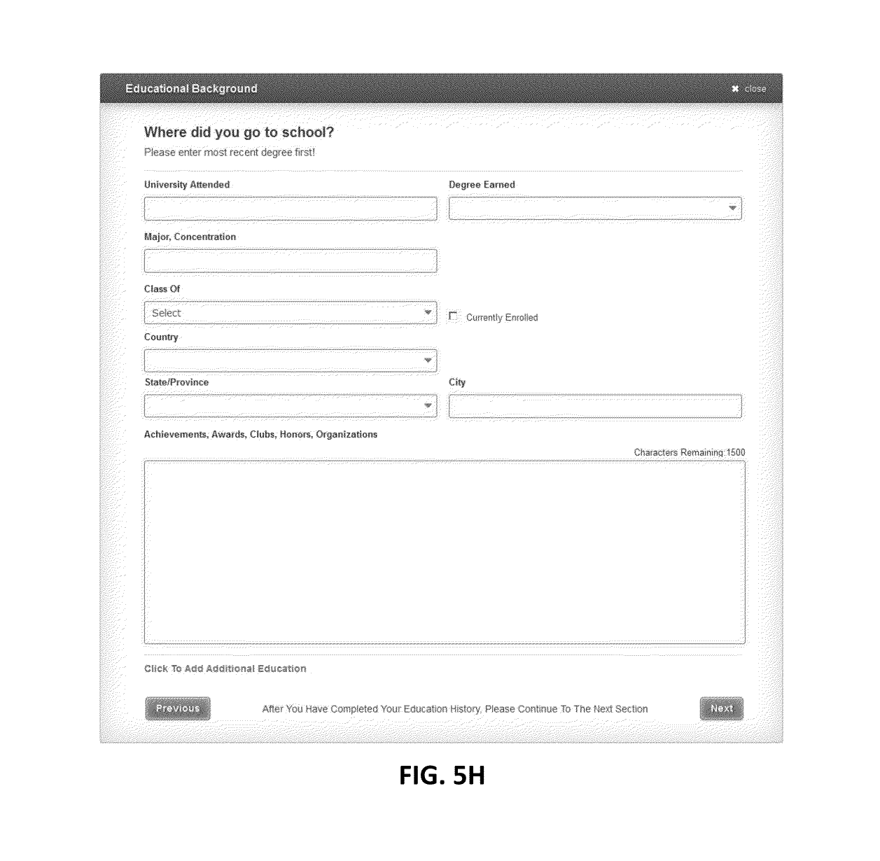

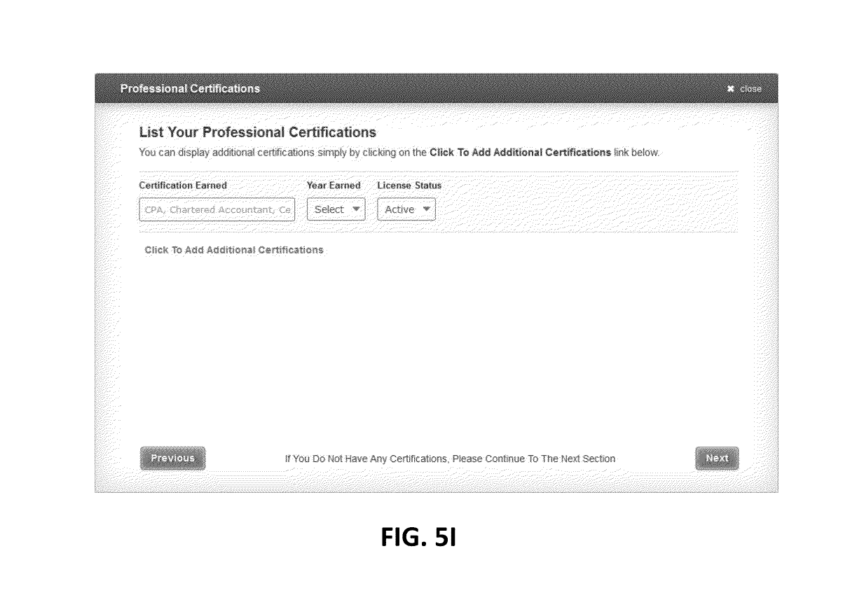

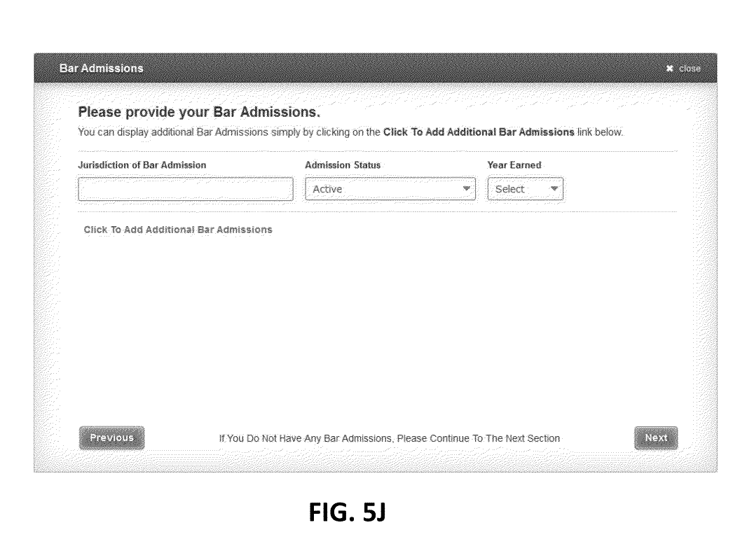

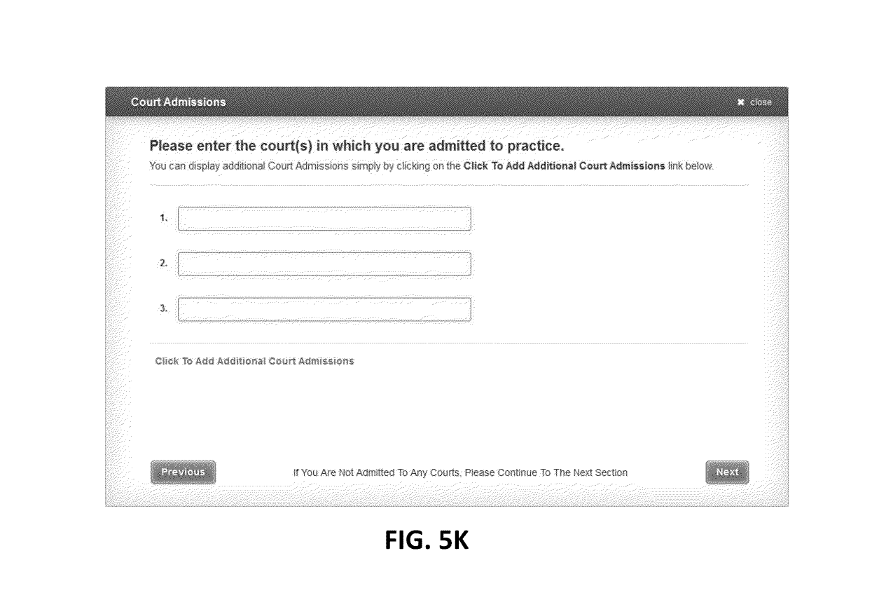

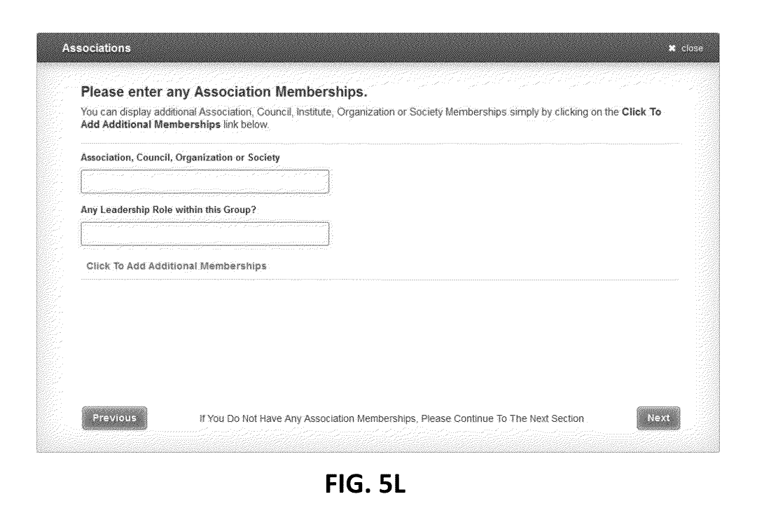

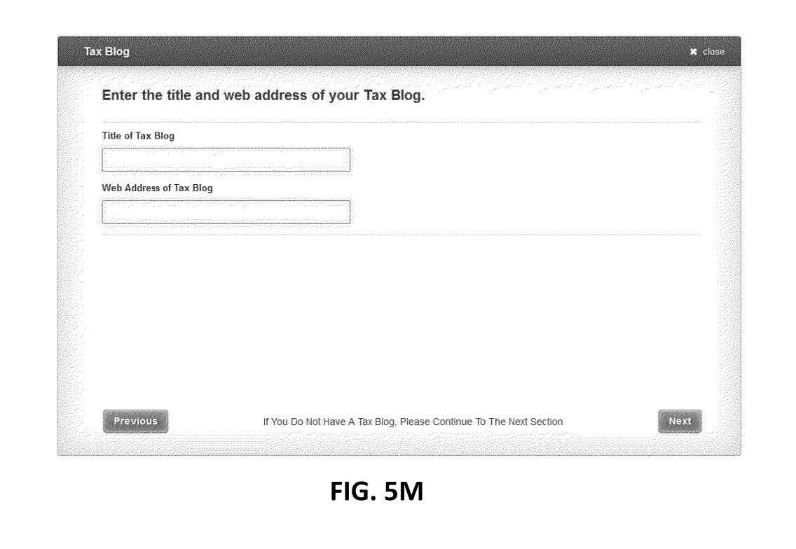

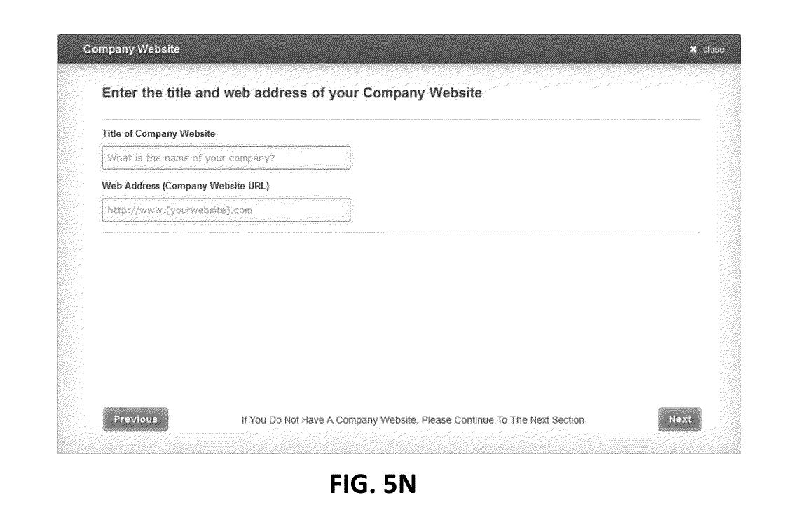

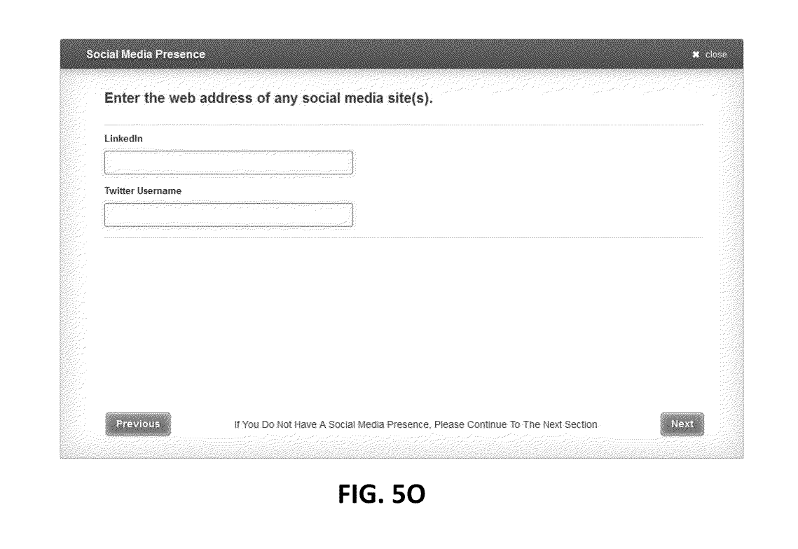

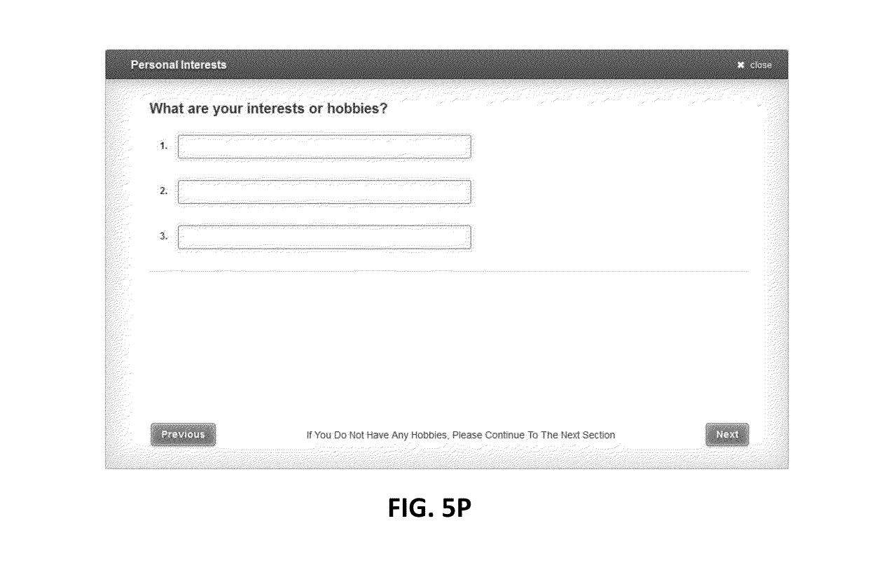

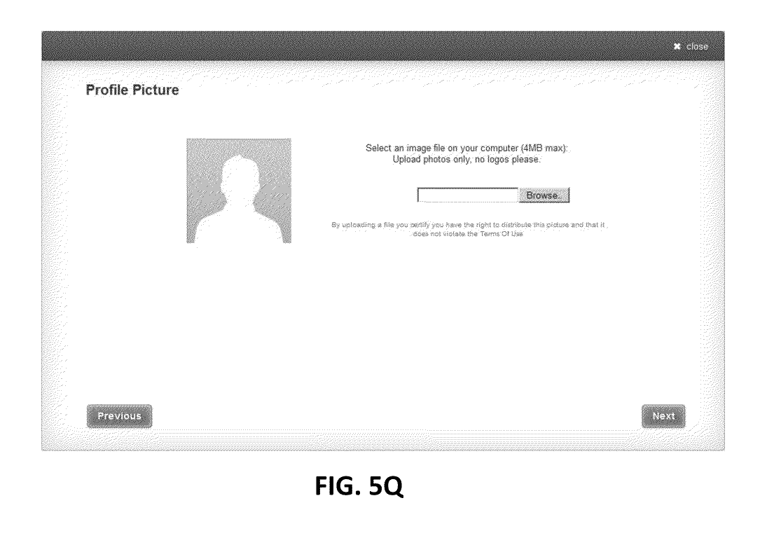

FIGS. 5A-5Q illustrate a registration process, according to an embodiment. As illustrated in FIG. 5A, the registration process may comprise four stages, and the progress of registration can be depicted in a progress bar at the top of one or more user interfaces served to a registering user during registration.

In the first stage, a user is prompted to provide sign-up information. An example user interface for collecting such sign-up information is illustrated in FIG. 5A. This user interface may comprise inputs that enable the user to enter first name, last name, email address, password, promotional code, etc. The user interface may also provide information regarding the benefits of purchasing a professional user account, and require the user to agree to a terms of use and/or privacy policy. Once a user has entered all required information, he or she can submit the inputted information and move to the second stage of registration.

In the second stage, the user is validated or verified. This validation can be performed using the email address submitted by the user in the first stage. For instance, as illustrated in FIG. 5B, after completing the first stage, the user may be prompted to check his or her inbox (and, optionally, spam folder) at the email address provided.

A registration module may send an email message to the user's email address. This email message may comprise instructions and a URL hosted by platform 110 for validating the user's email address. If the user clicks on the URL, platform 110 will receive a request (e.g., an HTTP GET request) for the URL, and the registration module executed on platform 110 can verify that the email address is valid based on this request.

In response to validating the user's email address, the registration module may send a confirmation email message to the user's email address. The confirmation email message may confirm that the user has been validated and successfully registered, and may optionally provide a link for logging into one or more applications (e.g., web applications) executing on platform 110.

In addition, in embodiments which comprise an internal messaging system, a messaging module may send a notification email message to the user whenever a new message is received for the user by the internal messaging system. For example, the notification email may inform the user about the new message, and may optionally provide a URL for logging in and viewing the message received via the internal messaging system. As an example of a notification message, after a user has been validated with the registration module, the registration module may send a welcome message to the user via the internal messaging system.

Once a user has been validated, he or she may be prompted or otherwise be provided the ability (e.g., via hyperlink to a further aspect of the registration module) to move on to a third stage of the registration process. In the third stage, the user is provided inputs for entering personal information, contact information, professional information, social networking information, and the like about himself or herself. These inputs may be provided via a wizard comprising a plurality of user interfaces, wherein each of the plurality of user interfaces is directed to a different set of information and is linked to a preceding and/or following user interface (e.g., via “previous” and/or “next” hyperlinks or other inputs). Example user interfaces of an embodiment of such a wizard are illustrated in FIGS. 5C-5Q. While the illustrated wizard is specific to the tax profession, it should be understood that the wizard may be similarly configured for any type of profession (e.g., medical profession, general legal profession, general accounting profession, etc.). In addition, while the user interfaces of the wizard are provided in a specific order, it should be understood that they may be provided in any order.

As illustrated in FIG. 5C, the user is prompted to enter personal information, such as salutation, first name, middle name, last name, year that the professional's career started, date of birth, mobile phone number, business phone number, second email address, Skype™ name, etc.

As illustrated in FIG. 5D, the user is prompted to enter one or more (e.g., up to five) languages that he or she speaks.

As illustrated in FIG. 5E, the user is prompted to identify one or more (e.g., up to three) areas of primary expertise.

As illustrated in FIG. 5F, the user is prompted to enter a professional summary (e.g., an overview of the user's tax expertise). This provides the user with an opportunity to associate himself or herself with a wider range of knowledge and expertise.

As illustrated in FIG. 5G, the user is prompted to enter an employment history. The user may be provided with one or more input frames, and given the ability to add additional input frames. Each input frame may comprise one or more inputs for entering information about a single employer, including, without limitation, the name of the employer, title, location, state/province, city, postal code, start date of employment, end date of employment (if any), type of organization, type of industry, company sales, country currency, job description, etc.

As illustrated in FIG. 5H, the user is prompted to enter an educational history. The user may be provided with one or more input frames, and given the ability to add additional input frames. Each input frame may comprise one or more inputs for entering information about a single educational institution, including, without limitation, the name of the university, degree earned, major or concentration, year of graduation (if any), country, state/province, city, achievements, awards, clubs, honors, organizations, etc.

As illustrated in FIG. 5I, the user is prompted to enter professional certifications. The user may be provided with one or more input frames, and given the ability to add additional input frames. Each input frame may comprise one or more inputs for entering information about a single certification earned, including, without limitation, the name of the certification, year the certification was earned, license status, etc.

As illustrated in FIG. 5J, the user is prompted to enter bar admissions. The user may be provided with one or more input frames, and given the ability to add additional input frames. Each input frame may comprise a one or more of inputs for entering information about a single bar admission, including, without limitation, the jurisdiction of the admission, admission status, year the admission was earned, etc.

As illustrated in FIG. 5K, the user is prompted to enter the court(s) in which he or she is admitted to practice. The user may be provided with one or more input frames, and given the ability to add additional input frames. Each input frame may comprise one or more inputs for entering information about a single court admission, including, without limitation, the name of the court.

As illustrated in FIG. 5L, the user is prompted to enter associations, councils, organizations, or societies of which he or she is a member. The user may be provided with one or more input frames, and given the ability to add additional input frames. Each input frame may comprise one or more inputs for entering information about a single association membership, including, without limitation, the name of the association, any leadership role, etc.

As illustrated in FIG. 5M, the user is prompted to enter information about any tax blog that the user may have. This tax blog information may include, for example, the name of the tax blog, URL of the tax blog, etc.

As illustrated in FIG. 5N, the user is prompted to enter information about a company website. This company website information may include, for example, the title of the company website, URL of the company website, etc.

As illustrated in FIG. 5O, the user is prompted to enter information about one or more social media sites of which the user is a member. This social media information may include, for example, usernames for one or more social media sites (e.g., a LinkedIn™ identifier or URL, a Twitter™ username, etc.), etc.

As illustrated in FIG. 5P, the user is prompted to enter information about one or more (e.g., three) of the user's personal interests.

As illustrated in FIG. 5Q, the user is prompted to upload a profile image. For instance, the user may be provided with an input for selecting and uploading an image from the user's personal computing device.

Once a user has entered all of the required information, the user's profile is complete, and the user is moved to the fourth stage, in which he or she is able to access various features of the website application executed on server(s) 110 that unregistered and/or non-professional users may not. The user may be permitted to subsequently review the entire profile and/or edit/view specific portions of the profile.

It should be understood that, after a professional user has successfully registered via the above process, any or all of the information entered by the user during registration (e.g., location, languages spoken, expertise, professional summary, experience, education, etc.) can subsequently be used to match and/or weight the professional user with language-based search criteria entered or selected by another user seeking professional assistance through the web application of platform 110.

10. Profile Module

In an embodiment, the web application comprises a profile module. The profile module generates one or more profile user interfaces for each professional member. The profile user interface can be viewed by other users, for example, when other users click on the professional member's name and/or image wherever they may appear on any of the web pages of the website of the web application. A professional member's profile user interface may display information about the professional member, so that users can view the overall tax knowledge, expertise, and qualifications of the tax professional member. All or a portion of the information displayed on the profile user interface of a member may be received from the member through a registration process of the registration module.

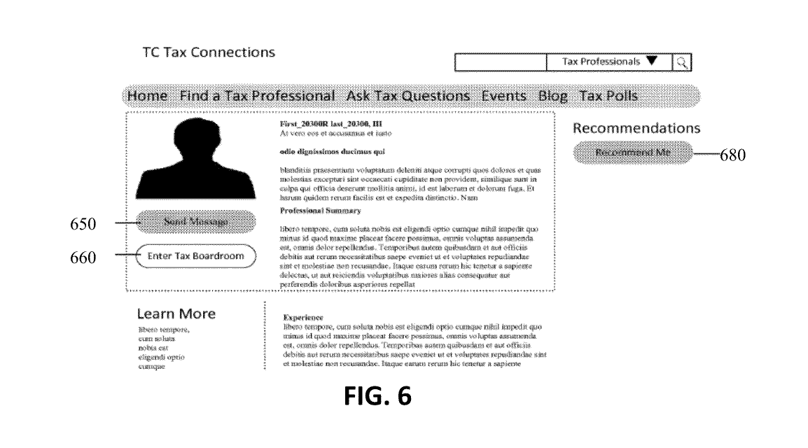

FIG. 6 illustrates an example of a profile user interface, according to an embodiment. The profile user interface may comprise information about the associated professional member, including name, title, company name, professional summary, experience, education, certifications, admissions, languages spoken, and the like. The user interface may also comprise inputs for sending the member a message, requesting entry into the member's boardroom, recommending the member, and/or reading a blog associated with the member. In addition, the user interface may comprise a list of user recommendations of the member, a list of questions recently answered by the member, and/or a list of recent blog entries published by the member.

The profile user interface may comprise a “send message” input 650 (e.g., button) which allows a user to send a message directly to the professional member associated with the profile user interface. If a user clicks on “send message” input 650, the web application may display a pop-up which allows the user to send a message to the tax professional member via the web application's messaging system. If the user is not logged in, the user may be routed to the login page before being able to send a message.

The profile user interface may also comprise a “boardroom” input 660 (e.g., button) which allows a user to go to the professional member's boardroom (e.g., tax boardroom). If a user clicks on “boardroom” input 660, the user may be directed to the professional member's boardroom, which is described elsewhere herein. In an embodiment, a user must “connect” with the member prior to being permitted to enter the member's boardroom (e.g., through a request and acceptance procedure). Thus, prior to connection, input 660 may be replaced with a “connection” input, which invites the user to connect with the member. If the user clicks on the connection input, the user may be prompted to send a request for connection to the member. If the member accepts the request, then the user will be connected with the member, and the next time the user view the profile user interface, the connection input will be replaced with “boardroom” input 660 which allows the user to enter the member's boardroom.

The profile user interface may also comprise a “recommend” input 680 (e.g., button) which allows a user to recommend a tax professional. If a user clicks on “recommend” input 680, the web application may display a pop-up or other user interface which allows the user to send a message to another user via email and/or the web application's internal messaging system. If the user is not logged in, the user may be routed to the login page before being able to send a message. The pop-up may comprise inputs which allow the user to enter and/or select the user's name, title, company, and/or text comprising the user's recommendation (e.g., a testimonial about the professional member). The pop-up may also provide the user an option to inform the professional member about the user's recommendation via a message (e.g., a textbox in which the user can type a message to the professional member being recommended). Additionally or alternatively, the user may submit a general recommendation that is not sent to another user but which is used to rate the member and/or determine a weighting coefficient or tier for the member that is applied by the professionals-search module during searching.

11. Tax Boardroom Module

In an embodiment, the web application provides each professional member with a virtual tax boardroom. As mentioned elsewhere herein, a professional member's profile user interface may comprise an input for interacting with the professional member in his or her private tax boardroom. In addition, such an input may be provided for each of a plurality of professional members who appear in a user's search results.

If a user clicks “boardroom” input 660 and is logged in, the user may be directed to a boardroom-request user interface (e.g., which may comprise a pop-up or other user interface). If the user is not logged in, the user may be directed to the login page. Using the boardroom-request user interface, a user may request entry to the professional member's tax boardroom by entering identification information and/or a message. For example, the boardroom-request user interface may comprise inputs for a user to identify his or her connection to the professional member (e.g., business associate, colleague, client, new potential client, friend, just curious, etc.) and a message introducing himself or herself. This information allows the professional member to screen users who wish to participate in his or her boardroom.

Once a user submits his or her request using the boardroom-request user interface, a message or other notice may be sent to the corresponding professional member. For example, the message may be sent to the professional member's inbox and/or another folder or section in the professional member's internal messaging interface (e.g., an “Invitations to Boardroom” folder or section). The notice may comprise an input through which the professional member may approve the connection and allow the user to enter the professional member's associated boardroom.

Forcing users to request access to a professional member's boardroom prior to being granted access allows a professional member to screen out anyone that they do not want having access to his or her private area, including advertisers, recruiters, human resources, or anyone else whom they feel may waste his or her time. Conventionally, screening presents one of the biggest time-wasting activities for tax professionals. The web application may provide well-written template letters that a professional member can utilize to screen out anyone that they cannot or do not wish to help or otherwise connect with.

The virtual boardroom (e.g., virtual tax boardroom) allows a professional member to communicate more privately about issues (e.g., tax issues), as well as screen users prior to establishing direct communication about issues. For instance, there may be some tax issues which users may not want posted in the open (e.g., using the questions module). The boardroom is a private or semi-private user interface that allows the seeking user to communicate in a one-on-one setting with a professional member. The virtual boardroom may allow the seeking user to continue to post messages for the professional and receive responses to those messages, but in a private setting that is not viewable by other users. Alternatively or additionally, the virtual boardroom may comprise network-based video and/or audio conferencing. For instance, in an embodiment, the tax boardroom may comprise the ability to video conference face-to-face (e.g., using a third-party service such as Skype™ or an internal system) so that a user can talk face-to-face with a tax professional member (e.g., over an Internet connection). The web application may provide a dashboard for each professional member, which allows the professional member to manage and organize all of his or her private communications with other users.

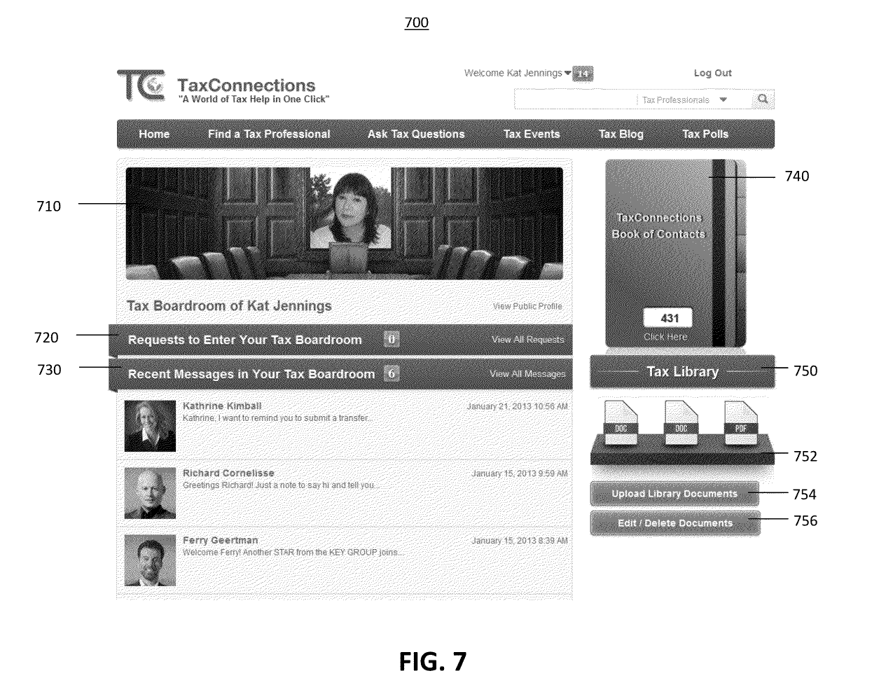

FIG. 7 illustrates an example user interface 700 of the boardroom module that is accessible by the professional associated with the boardroom, according to an embodiment. The user interface may comprise a boardroom graphic 710, which may include a photograph (e.g., profile image) of the professional associated with the virtual boardroom. In addition, the user interface may comprise a list of requests 720 to enter the boardroom, an inbox 730 comprising messages sent to the professional by other users, a virtual book of contacts 740, and a library 750 (e.g., tax library).

Requests list 720 comprises a list of all unanswered requests to enter the boardroom sent by users to the professional associated with the boardroom. Each request in the list may comprise information about the user who sent the request (e.g., name, profile image, etc.) and/or a message submitted by the user, as well as an input for confirming/allowing the request. Once the professional confirms the request, the user who submitted the request may be granted access to features (e.g., video chat, messaging, etc.) of the professional's boardroom. Otherwise, if the professional denies the request, the user will not be granted access to these features. In either case, the request may be removed from requests list 720 once confirmed or denied.

Inbox 730 comprises messages sent by users to the professional associated with the boardroom. In an embodiment, inbox 730 may only comprise new (e.g., previously unread) or recently received messages. Alternatively, inbox 730 may comprise all messages received by the professional, which the professional has not moved to another folder or archived. The virtual boardroom may comprise a communications archive of past communication sent to and/or by the professional. The archive enables the professional to keep track of his or her communications with other users.

Virtual “book of contacts” 740 allows the professional to keep track of contact information for all of his or her contacts (e.g., the users that have been granted access to the boardroom). The “front” of the book of contacts may list the number of users that the professional has screened and to whom the professional has granted access to the boardroom. If the professional clicks on the book of contacts, an alphabetized list of his or her contacts may be displayed.

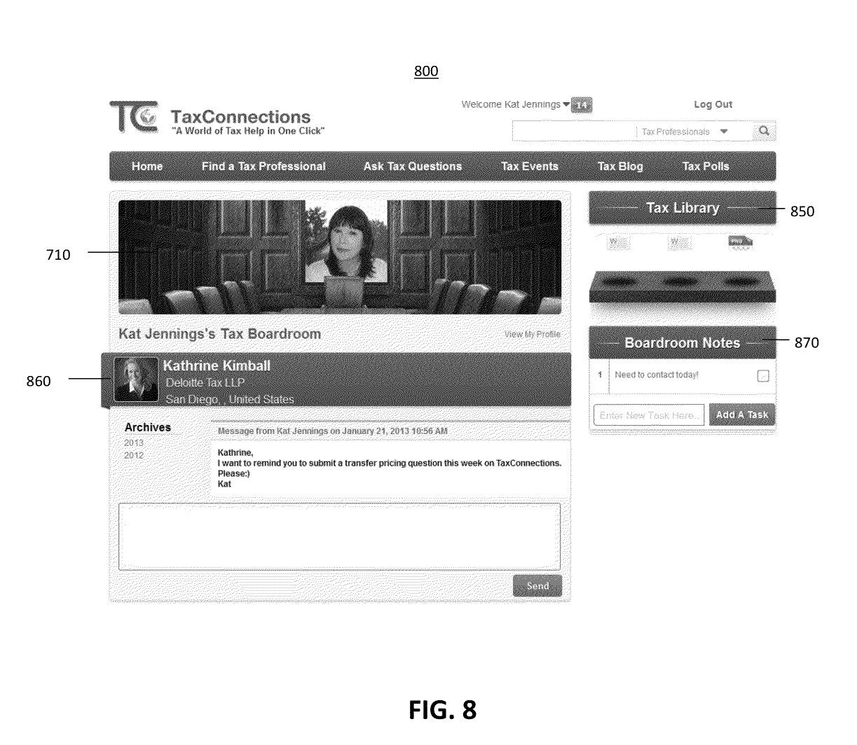

If the professional selects a contact (e.g., by clicking on the contact) from the book of contacts, the professional may be directed to a contact-specific user interface, such as the user interface 800 illustrated in FIG. 8. User interface 800 comprises a message frame 860, which allows the tax professional to view recent and past messages from the contact, as well as compose and submit a new message to the contact. The interface may also comprise a contact-specific tax library 850, and boardroom notes 870. Boardroom notes 870 allows the professional to input and manage private notes regarding the contact. These private notes may comprise dated tasks, reminders, etc.

User interface 800 may be accessible by both the professional associated with the boardroom, as well as users who have been granted access to the boardroom. However, it should be understood that one or more features of interface 800 may be different for the professional and visiting user. For example, notes in boardroom notes 870 that are entered by the professional may only be visible and accessible to the professional, and notes in boardroom notes 870 that are entered by a user visiting the boardroom may only be visible to the visiting user.

User interface 700 may also comprise a library 1750, in which the tax professional associated with the boardroom may promote or display documents of his or her choice. The web application may limit the number of displayed documents to a predetermined number (e.g., nine). Library 750 may comprise a list of documents in the library 752, each of which may be represented by a selectable icon which directs a user to the corresponding document. Library 750 may also comprise an input 754 for uploading a new document to the library and/or an input 756 for editing or deleting a document in the library.

It should be understood that user interfaces 700 and 800 may comprise other features which are not illustrated in FIGS. 7 and 8. For example, user interface 700 may also comprise a calendar (not shown) or a link to a calendar. The calendar may allow a professional to enter, modify, and otherwise manage appointments or other notes on a virtual calendar display. User interfaces 700 and/or 80 may also comprise a link to the associated professional's public profile page.

12. Feedback Module

In an embodiment, the web application comprises a feedback module which can receive ratings, comments, recommendations, and/or other input about a professional. The web application may utilize this feedback to generate a rating for each professional. For example, the web application may be configured to run various algorithms on the feedback to rate the professionals, or generate a weighting coefficient and/or determine a tier for each professional. The generated ratings or other feedback, weightings, tiers, etc. can be used to filter the professionals in response to a search request, as a search selection criterion, to evaluate the professional for continued membership with the web application, etc.

In an embodiment, the web application may comprise a feedback engine which receives input(s) related to activity by a professional on the web application. Such input may comprise answers to questions, event postings, participation in discussions, etc., including the frequency and/or ratings of such activities. The input to the ratings engine may also include feedback (e.g., recommendations, “likes”, “dislikes”, or other ratings, etc.) from users who have engaged the professional member's services. The ratings engine may output a ranking for the professional that can be input to a search engine.

13. Messaging Module

In an embodiment, the web application comprises a messaging module. The messaging module may provide each member with an inbox, which comprises the main messaging center for professional members and non-professional members alike. The messaging module may comprise user interfaces similar to any standard email account with user interfaces for an inbox, a list of sent messages, and a list of deleted messages. The user interfaces of the messaging module may also comprise a “compose message” input (e.g., button) which brings up a pop-up or other user interface for a user to compose a message, including identifying to whom to send the message (e.g., by selecting from a drop-down or list menu of the user's connections/contacts), inputting a subject of the message, and inputting a body of the message.

In the inbox user interface, the user can view a message, reply, and/or move a message to a deleted messages folder. The inbox user interface may also comprise additional functionality, such as forwarding a message to another member, replying to all users associated with a message, and/or marking various messages as deleted, read, or unread.

In an embodiment, the inbox user interface comprises a list of selectable folders and a list of message records (e.g., emails) that have been received for the member associated with the inbox being viewed. Each message record may comprise at least a portion of the associated message's subject and/or body, as well as information about the sender (e.g., name, image, etc.), time that the message was sent and/or received, a link for deleting and/or flagging the message, etc. In an embodiment, the messaging module implements thread-based messaging. In such an embodiment, each message record may comprise the date and/or time, sender, subject line, and/or snippet of the latest correspondence in the thread and may also comprise the number of messages in the thread. When a user clicks the thread (e.g., in the inbox), the entire thread may be opened, so that the user can see the complete history of the discussion. If the user is outside of the thread, the history of the thread will be maintained. If the user is outside of the thread and clicks to compose a message, a new thread may be started.

The inbox user interface may allow users to flag a message to indicate its importance, block the sender of the message, etc. The inbox user interface may also allow users to delete messages, view deleted messages, empty messages from the deleted messages folder, view sent messages, create and manage folders for segregating messages, and any other features that are typical of email applications. Each listed folder (e.g., inbox, boardroom, sent, deleted, and/or user-generated folders) may be selectable and indicate the number of new (e.g., unread) messages in the folder. If a user selects a listed folder, a user may be directed to a user interface similar to the inbox user interface but listing messages stored in the selected folder.

The inbox user interface may also comprise a search box for searching messages, a compose message button or link which directs the user to a user interface for composing a message, and an inbox button or link which directs the user to the inbox user interface (i.e., comprising a list of messages in the inbox). In addition, the inbox user interface may comprise a boardroom button or link, which allows the user to view requests from users to be granted access to the user's boardroom and/or view other messages or conversations occurring in, or otherwise related to, the user's boardroom. The inbox user interface may also comprise a manage lists button or link, which directs the user to a user interface that allows the user to generate and/or manage groups of contacts.

For example, the user may generate a list or group comprising a subset of one or more of his or her contacts. In an embodiment, the user may generate a group by inputting a name for the group and selecting one or more of his or her contacts to be associated with the group. Alternatively or additionally, the system may automatically generate one or more groups, such as a default group comprising all of a user's contacts or a subset of the user's contacts (e.g., all contacts that have been confirmed for the user's boardroom).

In an embodiment, a contact-groups user interface is provided for managing contact groups. A user may access this interface by selecting the manage lists link. The contact-groups user interface comprises a list of previously generated contact groups, if any, and allows a user to view, edit, and/or delete the previously generated contact groups. The contact-groups user interface also allows a user to generate a new contact group (e.g., by selecting a link or other input).

If a user chooses to generate a new contact group, the user may be directed to a contact-group-naming user interface. The contact-group-naming user interface may be accessed, for example, by a user selecting link on the contact-groups user interface. The contact-group-naming user interface provides the user with an input for naming a new contact group. Once the user has submitted a name for the contact group, the user may be directed to an add-group-contacts user interface. The add-group-contacts user interface allows a user to add contacts to or subtract contacts from a contact group. The add-group-contacts user interface may be configured to automatically suggest contacts to add based on characters that the user inputs into an add-new-contact input (e.g., textbox) for naming a new contact. For example, as a user types in characters into the add-new-contact input, a drop-down list may appear. The drop-down list may comprise a record for each contact in the user's contacts that matches the input characters in the add-new-contact input. The user may select one of the records in the drop-down list, and, in response, to the selection, the contact is added to add-new-contact input. The user may continue to do this until add-new-contact input comprises a list of one or more contacts that the user wishes to add to a list. It should be understood that automatic suggestion may be performed by a script executing in the user's browser application or by some other mechanism. Automatic suggestion mechanisms are well-known in the art, and thus, will not be described in detail herein. Also, it should be understood that the described user interfaces may, together, constitute a wizard (i.e., series of associated user interfaces) for generating a new contact group.

In an embodiment, the user may only be permitted to add contacts with whom they are connected (i.e., a handshake, such as a request and acceptance or confirmation, has been performed between the two members) to a contact group. In this embodiment, if a user attempts to type or enter a name that does not match a member with whom they are connected into the add-new-contact input, an error message informing the user that he or she must select from his or her connected contacts, or other indication, may be displayed.

In an embodiment, a contact-group-editing user interface may be provided. The contact-group-editing user interface allows a user to edit a contact group, and may be accessed, for example, by selecting a link of the contact-groups user interface that is associated with a particular contact group. As illustrated, the contact-group-editing user interface comprises a list of contacts who are associated with the group, allows a user to add one or more new contacts to the group, allows a user to remove one or more contacts from the group, etc. In an embodiment, each contact record in the list of contacts may comprise the contact's profile image, name, title, company, expertise(s), location, panels, one or more inputs for interacting with the contact record (e.g., selecting the record for a group change, removing a record, etc.), etc.

Lists or contact groups allow a user to quickly compose a message that is broadcast to a subset of his or her contacts. For instance, a compose-message user interface may be provided for composing a message and may comprise a contact-group-selection input for selecting one or more of the contact groups as the recipient of the composed message. For instance, the contact-group-selection input may comprise a drop-down menu listing the name of each group. If the user selects a group, then, when the user sends the message, the message will be sent to each contact associated with the selected group. In an embodiment, these messages may be sent out as a plurality of one-to-one messages, rather than a single, one-to-many group message which would allow recipients to identify and/or respond to other recipients. However, in other embodiments, these messages may be sent as a single group message or allow a user to select whether to send the message as one-to-one or one-to-many. In additional embodiments, the contact-group-selection input may allow the user to select a plurality of contact groups, rather than just one group of contacts.

Using the contact-group-selection input, a user may select a group of contacts in addition or alternatively to entering contact information manually into a recipient input (e.g., textbox). In an embodiment, the recipient input may perform automatic suggestion, for example, implemented as an embedded or external script executing in a user's browser application. As a user types characters representing a contact's name into the recipient input, the script or other mechanism may search the user's contacts, identify one or more contacts matching the typed characters, and provide selectable suggestions (e.g., as a drop-down frame or panel under or otherwise adjacent to the recipient input) for the complete contact name. This automatic suggestion mechanism may be similar or identical to the mechanism described above in relation to the add-new-contact input.

In an embodiment, the user may only be permitted to send a message to members to whom they are connected (i.e., a handshake, such as a request and acceptance or confirmation, has been performed between the two members). In this embodiment, if a user attempts to type or enter a name that does not match a member with whom they are connected, an error message informing the user that he or she must select from his or her connected contacts, or other indication, may be displayed.

In an embodiment, the messaging module may enable users to set and manage alerts. For example, the messaging module may provide one or more user interfaces comprising inputs which allow a user to create or select or otherwise define alerts, as well as manage defined alerts for the user. In addition, the messaging module may provide default or system-defined alerts. The alerts may comprise one or more criteria which are continually compared to activities occurring in the online community provided by the web application. If the alert criteria match an activity, an alert or other notification message (e.g., email or messaging using an internal messaging system) may be sent to the user who set or is otherwise associated with the alert. For example, a member may be alerted if a new job is posted or if an employer expresses an interest in the member or an individual with the member's expertise or qualifications, a new event is posted, a new panel is featured, a new survey is posted, the member has been recommended by a user, etc.

By way of illustration and not limitation, in an embodiment, alerts may be set for the following non-exhaustive list of activities or interactions: request for entry to the user's boardroom, acceptance of the user for entry into another user's boardroom, a message posted in the user's boardroom, participation in a survey or poll (e.g., tax salary survey), a recommendation posted for the user, a comment posted for the user's tax question, feedback (e.g., a “like”) posted for the user's answer to a tax question, a mention of the user in a blog or other post, participation as a panelist, birthday notifications for the user's contacts, refer-a-friend alerts, creation of new tax communities, notifications new users to a tax community created by the user, requests to join a tax community created by the user, approval of the user to join a tax community, posting of a new tax question, posting of an answer to the user's tax question, submission of new tax questions, submission of new answers to tax questions, notification that the user's answer has been rated or otherwise marked as the best answer, a comment posted for the user's tax question, notification of new professionals in the user's area, posting of an event, posting of a blog or blog entry, notification of a new blogger, Twitter™ post, cancellation of an event, posting of new or recent photographs for an event, new members to a tax association, posting of a new tax poll, upload of a new video or other media, a comment posted on the user's uploaded video or other media, replies posted for a customer question, notification of continuing education classes, new activity in a community discussion, new members to a community, new tax ambassadors, new job postings, new job descriptions, a new message in the user's inbox or boardroom, expert panel notifications, mergers and acquisitions updates, newsfeeds, notification of hottest topics (e.g., tax topics), new tax tips, new professional members, top bloggers, top tweeters, notifications of conferences, notifications of webinars, conference speaker engagements, notifications of tax internships, and/or alerts related to the user's interests and hobbies (e.g., new users with similar interests or hobbies).

14. Connections Module

In an embodiment, the web application comprises a connections module. The connections module comprises one or more user interfaces which allow a member to manage his or her connections through the web application. Accordingly, the connections module may be similar to, interfaced with, mixed with, inclusive of, or integral to the messaging module and/or boardroom module. In an embodiment, the connections module may allow a user to view current connections, receive suggestions about potential connections, view connection statistics, add connections, and/or remove connections.

In an embodiment, the connections module may comprise a list of a user's current tax connections. The list may comprise one or more connection records. Each connection record may correspond to a member with whom the user has connected (e.g., via a request and acceptance scheme) and may comprise the member's profile image, name, title, company, location, one or more inputs for selecting (e.g., for a group change) or managing (e.g., editing, deleting, etc.) the connection, etc. Each connection record may also be selectable such that the user may view and/or edit the connection (e.g., corresponding member information) in more detail (e.g., in a frame of the same web page or on a separate web page).

In an embodiment, the connections module may comprise a list of members whom a user may know or with whom the user may wish to be connected. Each member record in the list may comprise the member's profile image, name, title, company, location, and/or input for requesting to connect with the member through the web application. The list may also be filterable and/or sortable using one or more selectable or enterable criteria, such as keywords, current employer, previous employer, industry, college or university, city, expertise, associations, etc. The list of suggest members may be generated using various analytics which identify connections via a viewing member and other members. For example, the connections module may analyze connections throughout the web application to determine other members who are within a predetermined number of degrees of separation (e.g., two) from the member. Thus, if a first member is connected to a second member who is connected to a third member with whom the first member is not connected, the connections module may be configured to identify this indirect relationship and suggest that the first member connect with the third member (e.g., by including the third member in the list of suggested members).

In an embodiment, the connections module may analyze a user's connections and present the results of the analysis in a user interface to the user. For example, the user interface may comprise one or more graphs (e.g., bar graphs) which identify the percentage of connections by location, association, languages spoken, industry, certifications, title, expertise, educational degree, years of experience, or any other criterion. Initially, the statistics may be provided for only a certain predetermined number (e.g., top five) of instances for each criterion, but the user may be provided the option to view all instances. For example, a location-based statistic may indicate that a user's connections are distributed with 16% in San Francisco, 5% in San Diego, 3% in Chicago, 2% in Boston, and 2% in Los Angeles, with an option to “see all.” If the user clicks on “see all,” the user may be provided with a breakdown for the remaining 72% of his or her connections. The other statistics (e.g., association, languages spoken, etc.) may be provided in a similar manner.

In an embodiment, the connections module may comprise a user interface for adding connections. For example, the user interface may comprise an input for entering one or a plurality of email addresses, importing contacts from an external file (e.g., CSV file, XML file, etc.) or application (e.g., a social networking application, email application, etc.), and/or entering and/or selecting a message or template. For each input or imported contact, the connections module may generate and send an email message using the contact record and message or template. The email message may comprise an invitation to join the web application (e.g., by including a URL for the registration module). The connections module may be configured to identify fields in a message or template and replace the identified fields with data from a contact record. For instance, the template may comprise a “<name>” placeholder. For each email message that the connections module generates for a contact, it may replace this placeholder with the contact's name. In this manner, each email message can be quickly and automatically personalized.

15. Account Settings Module

In an embodiment, the web application comprises an account-settings module. The account-settings module may comprise one or more user interfaces which allow a member to change basic information in his or her account. For example, the account-settings module may comprise a first user interface which comprises inputs which allow a user to change his or her first name, last name, email address, etc. A second user interface may comprise inputs which allow a user to change his or her password.

If a user has connected to the web application through a third-party API (e.g., Facebook™, Twitter™, or LinkedIn™), the user interface for changing a password may not be accessible to the user, since changing the password could break their ability to log in through the third-party service. Instead, the user interface for changing the password may be replaced with an informational message, providing instructions on how to change the user's password at the third-party service through which the user logged in.

If a user is logged in as a basic member (e.g., free or non-professional member), he or she may be presented with an option (e.g., as a button or other input on a user interface of the account-settings module) to “upgrade” their membership from basic or free member to professional member. If a user chooses to upgrade their membership, the web application may redirect the user to a promotional code user interface and/or to a payment user interface, so that the user can complete the upgrade process and become a fully validated professional member. Once the upgrade process is complete, the web application changes the user's role (e.g., as stored in a database) to “professional.”

16. Communities

In an embodiment, the web application may provide one or more communities in which users may participate. For example, one or more of the modules or features described herein may be provided for two or more separate and distinct communities. These communities may be created and managed by the operator of the web application, users of the web application (e.g., professional members), or both. Alternatively, the communities may not actually comprise separate portions of the web application, but may simply be defined by the tags or topics associated with various postings (e.g., questions, answers, blogs, areas of expertise in professional members' profiles, etc.). Thus, all postings tagged with a certain topic may comprise a community for that topic. In some embodiments, communities may be defined both by segregated portions of the web application and tags or topics associated with postings through the web application.

In the context of a tax-related web application, the communities may be tax communities that include, without limitation, “Big Four” Alumni, Deloitte Touche™, Ernst & Young™, PriceWaterhouseCoopers™, KMPG™, Financial Services, Expatriates, FASB ASC 740 (FAS 109), Estate and Trust, Tax Lawyers, VAT/Indirect Tax, Transfer Pricing, State and Local Tax (SALT), Property Tax, Sales and Use Tax, EMEA (Europe, the Middle East, and Africa), Direct Tax, Film Tax, International Tax, Customs, Private Equity Tax, Life Insurance Tax, Property Insurance Tax, Latin America Tax, Health Insurance Tax, India Tax, China Tax, Asia Pacific Tax, Canadian Tax, Payroll Tax, Tax Credits and Incentives, Brazilian Tax, Hedge Fund Tax, Enrolled Agents, Partnership Tax, Corporate Tax, Individual Tax, Tax Dispute Resolution & Litigation, Federal Tax Audits, State Tax Audits, Foreign Tax Audits, Entertainment Tax, 1031 Tax-Deferred Exchanges, Irish Tax, Mergers & Acquisitions, Real Estate Tax, Tax Treaties, Computers and Tax, Tax Court, Tax Trade and Policy, International Tax Compliance, Indirect Tax, Economists, Legislative Issues, etc.

In an embodiment, the communities may also comprise a Careers/Opportunities community for connecting users with employment (i.e., with employer users). Alternatively, this may be a dedicated module (e.g., comprising one or more user interfaces) of the web application. The Careers/Opportunities community or module may be further divided by region. For example, it may include U.S. Tax Opportunities, Canadian Tax Opportunities, European Tax Opportunities, Asian/Pacific Tax Opportunities, Middle Eastern Tax Opportunities, Oceania Tax Opportunities, Latin American Tax Opportunities, and African Tax Opportunities. Each of these regional divisions may comprise opportunities to practice in that region and/or opportunities to practice in the tax law of that region.

In an embodiment, a community-directory user interface may be provided that for presenting a directory of communities. The community-directory user interface may comprise a list of available tax communities, including a name and brief summary for each tax community. The user interface may also comprise search inputs for searching the tax communities, for example, by keyword, location (e.g., country), and/or type. The search results may displayed in the same manner as the general community directory, but listing only those tax communities meeting the user-specific search criteria. In addition, the user interface may also comprise a list of recommended tax communities (e.g., as determined based on feedback and/or a profile of the viewing user, as well as an input for creating a new community (e.g., tax community). If a user selects a community, he or she may be directed to a community-specific user interface.

In an embodiment, a user interface may be provided which allows a user to view a selectable list of all the communities he or she is following or otherwise involved in. Additionally, a user interface may be provided which allows a user to select one or more communities which he or she is currently following or involved in and opt-out of receiving communications from the selected communities.

In an embodiment, a community-creation user interface may be provided for creating a new community (e.g., tax community). As illustrated, the community-creation user interface may comprise inputs for entering a name for the community, selecting a type for the community, selecting a country, entering a description of the community, entering a URL for a profile on a social network (e.g., Twitter™, Facebook™, etc.), uploading a logo image or avatar for the community, entering a URL for a website associated with the community, agreeing to a terms of use or an appropriateness of content, etc. In addition, the user interface may also comprise one or more inputs which control access to the community. For example, if the creating member (e.g., “Ambassador” of the community) selects “auto-join,” any professional may join the group without approval from the creator or other administrator of the community. However, if the creating member instead selects “request to join,” users must request to join the group and be approved by the creator or other administrator of the community. If a request to join is required, the creating member may also specify whether the community is displayed in the directory of available communities and/or whether members of the community may invite other users to join the community.

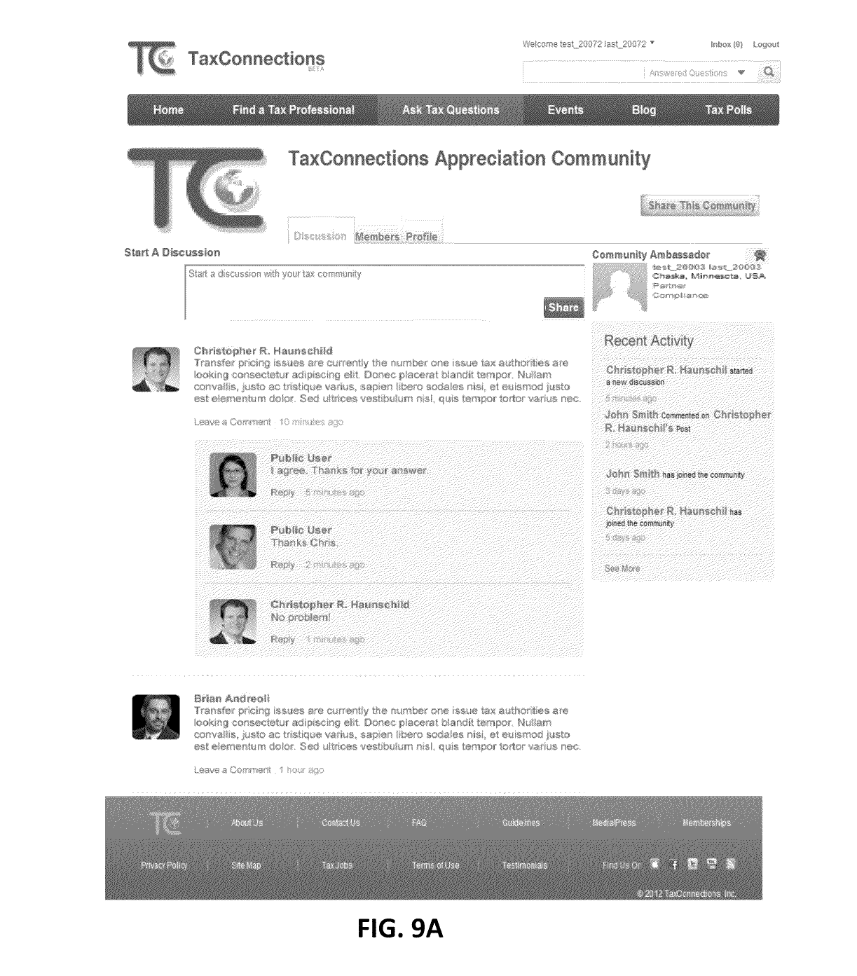

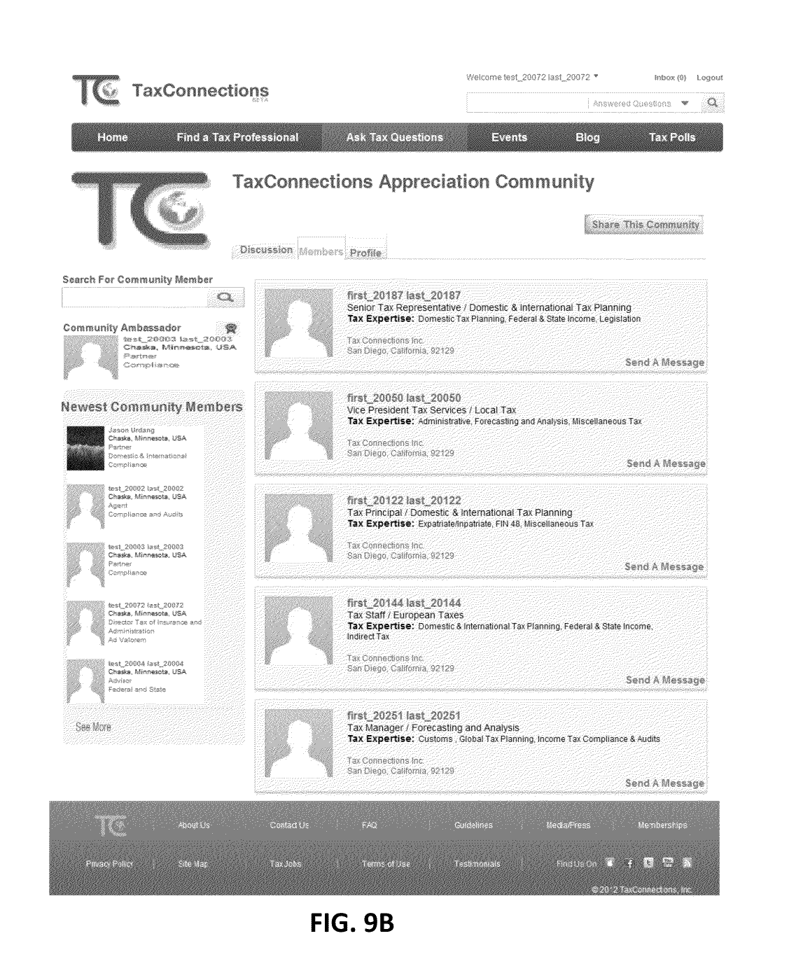

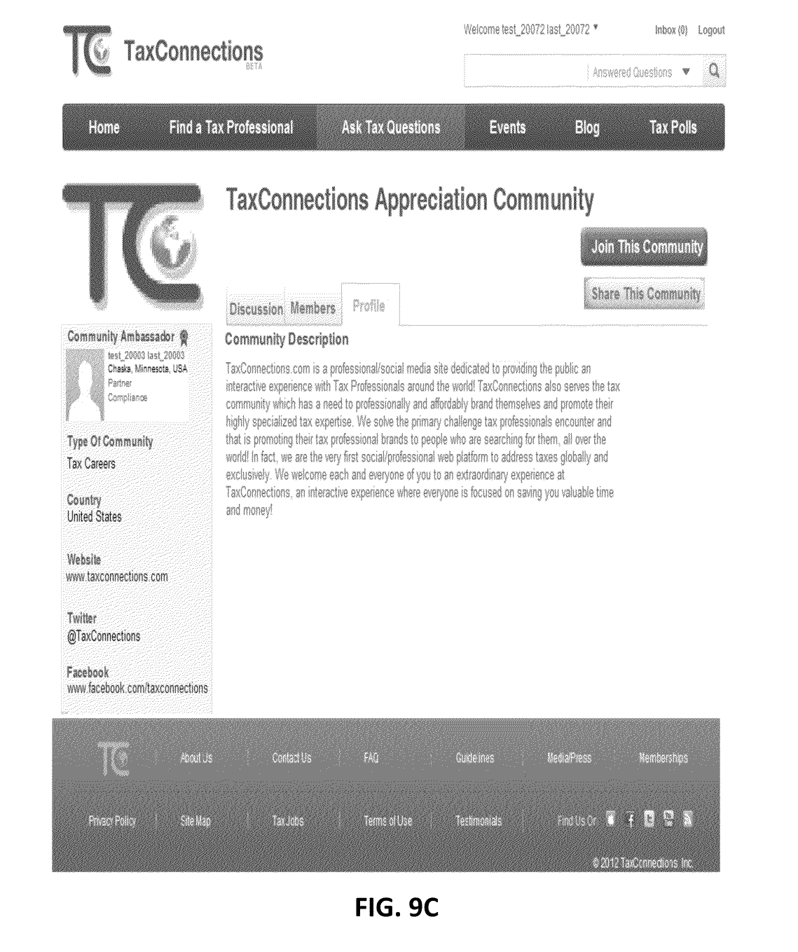

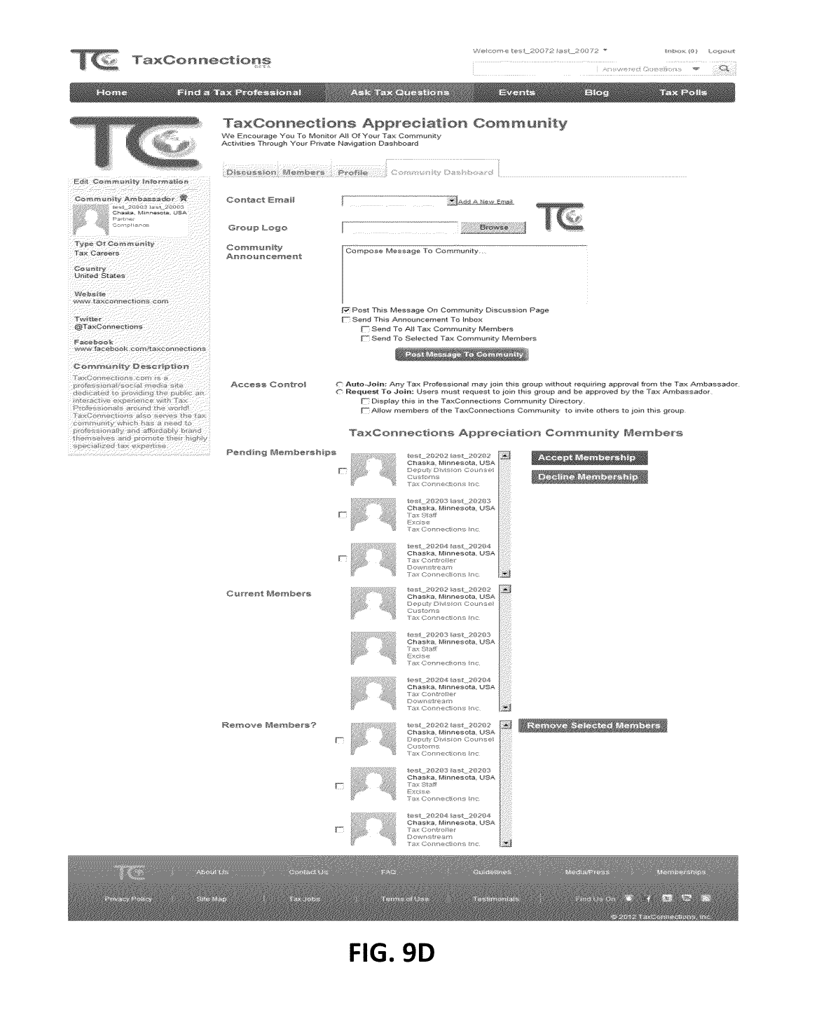

FIGS. 9A-9D illustrate an example community-specific user interface, according to an embodiment. The user interface may comprise one or more tabs. In the illustrated embodiment, the user interface comprises discussion, members, and profile tabs. The user interface for the creator or other administrator of the community may also comprise an additional dashboard tab.

FIG. 9A illustrates the discussion tab of the community-specific user interface, according to an embodiment. The discussion tab may comprise an input for starting a new discussion, and list prior and/or current discussions. The discussion tab may also provide a condensed profile of the community ambassador (i.e., creator or administrator) and list recent activities in the community, such as the creation of new discussions, the posting of new comments, and new members who have joined the community. Each discussion may comprise a thread of one or more comments, comments to comments, etc., and inputs for submitting a new comment or commenting on a comment. In addition, each listed comment may comprise a date and/or time and inputs for “liking” or “disliking” the comment, as well as indications of how many users have “liked” or “disliked” the comment.

FIG. 9B illustrates the members tab of the community-specific user interface, according to an embodiment. The members tab may comprise a list of each member who has joined the community in association with a condensed profile of the member and/or an input for sending a message to the member. For instance, each member record in the list may comprise the member's profile image, name, title, company, location, and an input for sending a message to the member. The members tab may also comprise one or more search inputs for searching the members of the community (e.g., by keyword, expertise, location, etc.), a condensed profile of the community ambassador, and a list of newest community members.

FIG. 9C illustrates a profile tab of the community-specific user interface, according to an embodiment. The profile tab may comprise a condensed profile of the community ambassador(s) or other administrator(s) (e.g., profile image, name, title, company, location, etc.), as well as other details associated with the community, such as the type of community, community country, website of the community, social networking accounts associated with the community, and a description of the community. The profile tab may also comprise inputs for joining the community or requesting to join the community and/or sharing the community with other individuals (e.g., by email or other message).

FIG. 9D illustrates a dashboard tab of the community-specific user interface, according to an embodiment. The dashboard tab may only be accessible by the community ambassador (e.g., the creator or administrator of the community). The dashboard tab may comprise details about the community, and one or more inputs for entering a contact email to be associated with the community, uploading a group logo to be associated with the community, posting a community announcement, composing a community announcement on the discussion tab or other tab, sending the composed announcement to members' inboxes (e.g., via email or an internal messaging system of the web application), sending the composed announcement to all community members or selected community members, posting the composed announcement, and modifying access controls for the community (e.g., whether access is by “auto-join” or “request to join”). In addition, the dashboard tab may comprise a list of all pending members (i.e., users who have request to join the community but who have not yet been approved) and current members (i.e., users who have joined the community). Each member in the list of pending members may be associated with an input (e.g., checkbox) which enables the community ambassador or other administrator to either accept the user for membership or decline the user for membership in the community. In either case, the acceptance or declination decision may be notified to the pending member. Each member in the list of current members may be associated with an input (e.g., checkbox) which enables the community ambassador or other administrator to remove the user from membership in the community.

17. Marketing Module

In an embodiment, the web application may comprise a marketing module which enables professional members (or, in some embodiments, other users) to market their services to users of the application, for example, through email or an internal messaging system. For instance, the marketing module may provide messaging features, contact management features, and/or library features.

Email features may comprise sending one or more emails to one or more users, scheduling one or more emails to be sent to one or more users, managing configuration information for the email marketing system, and generating one or more reports related to a professional member's marketing activities. For instance, if a professional member selects to send an email, he or she may be directed to a user interface for composing a message (e.g., to be sent via email or an internal messaging system). As another example, if a professional member selects to view reports, one or more reports regarding the member's marketing activities may be generated. For example, these reports may be presented in a user interface and provide statistics, including, without limitation, the number of emails sent by the member, number of “bounced” emails sent by the member, number of rejected emails sent by the member, number of complaints generated in response to emails sent by the member, number of delivery attempts for emails sent by the member, number of users who opted in to emails from the member, number of users who opted out of emails from the member, identifications of email addresses that bounced, etc. In an embodiment, these statistics may be segregated by and associated with separate marketing campaigns (e.g., email campaigns), and be presented in association with an identifier (e.g., name) of their associated marketing campaigns, along with the date that the campaign was undertaken.

Contacts features provided by the marketing module may comprise managing the professional member's contacts (i.e., other users with whom the professional member has a relationship), managing lists or groups of contacts, and creating new contact lists or groups. If a professional member selects to manage his or her contacts, the member may be directed to one or more user interfaces which enable the member to create a new contact (e.g., by entering contact information into one or more inputs), edit a contact, import contacts from a file (e.g., comma-delimited file, spreadsheet file, such as an Excel™ file, etc.) or another application, and/or find contacts (e.g., using a search input which queries a database using entered search terms). Contact information may include, without limitation, contact type (e.g., tax professional, Chief Executive Officer, Chief Financial Officer, Finance Professional, Human Resources, General Public, etc.), job title, expertise, prefix or title (e.g., Mr., Ms., Mrs., Dr., etc.), first name, middle name, last name, work email, personal email, company name, company address, company city, company state or province, company postal code, company country, home address, home city, home state or province, home postal code, home country, etc.

If the professional member chooses to find contacts, the member may be directed to a user interface comprising a search textbox. The member may submit search terms through the search textbox and, in response, be provided a list of matching contact records. For instance, each contact record may comprise the contact's first name, last name, email address, company, date of last active send-out (if applicable), date that the contact opted out from emails from the professional (if applicable), date that the contact was last edited (if applicable), etc. Each contact record may also be selectable (e.g., using a checkbox associated with each contact record). A member may select one or more or all of the contacts and select an input (e.g., button or link) that generates a new contact group or list comprising the selected or all contact records in the search results. An input may also be provided for generating a new contact group or list comprising all of the contact records in the search results.

Contact groups may be separately managed by the member. For example, if the member selects to manage contact lists, the member may be directed to a user interface comprising a list of the member's contact groups. Each contact group record may comprise the date that the group was created, a name for the group, a description of the group, number of emails in the group, date of last send-out for the group (if applicable), date that the group was last modified or edited (if applicable), etc. Each contact group record may also be associated with an input or link which allows the member to view all contacts within the group, as well as edit the group. If a member views contacts within a group, each contact may appear in a list of contact records, in which each contact record may comprise a contact's first name, last name, job title, expertise, email address, company, city, state, country, etc., as well as an input or link for viewing and/or editing the contact record.

The marketing module may provide a user interface for creating a contact group or list by entering and/or selecting one or more criteria to be matched to the member's contact records. Such criteria may include, without limitation, contact type, languages spoken by the contact, job title, expertise, first name, middle name, last name, work email, personal email, company name, company address, company city, company state, company state or province, company postal code, home address, home country, home state or province, home city, home postal code, etc. If the member submits the criteria, the member may be presented with a list of contact records which match the submitted criteriat. Each contact record in the list may comprise, without limitation, contact type, first name, last name, language, job title, expertise, company, city, state, country, personal email, work email, etc.

In an embodiment, the marketing module comprises or is interfaced with a library. The library may comprise templates and images which can be used by the professional member for marketing. Marketing module may provide a user interface through which a member may upload, view, edit, and/or otherwise manage templates. These templates may comprise templates for emails and/or letters, comprising tags that the marketing module may recognize and replace or fill in with contact-specific information, for each contact in a marketing campaign, prior to transmitting the filled-in template as an email or printing the template as a letter for sending. In addition, marketing module may provide a similar user interface through which a member may upload, view, edit, and/or otherwise manage images, e.g., to be used in marketing campaigns.

18. Jobs Module

In an embodiment, the web application may comprise a jobs module which allows employer users to post jobs, manage job postings, and/or find potential job applicants, and which allows job-seeking users to find job opportunities and submit job applications to posted job opportunities.

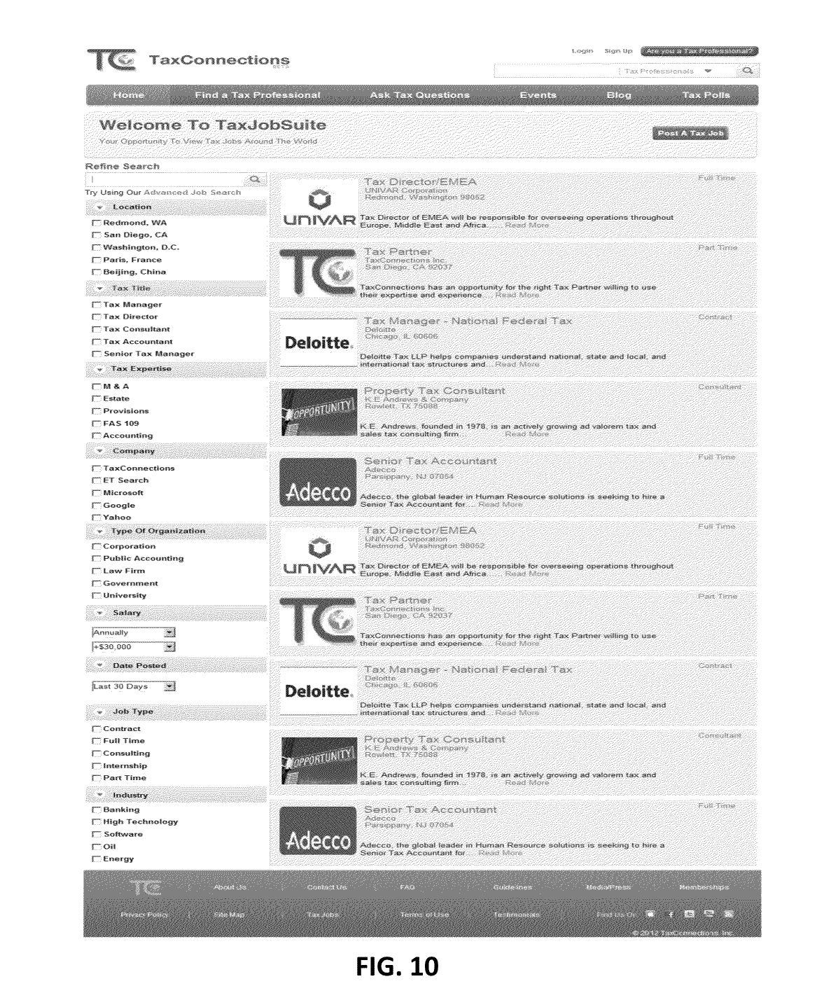

FIG. 10 illustrates an example user interface for listing available jobs (e.g., that have been posted through the jobs module). The user interface may comprise a list of all available jobs, as well as search inputs for specifying search criteria. If a user submits search criteria, the search results may be displayed in a similar manner as shown in FIG. 10. Examples of search criteria may include location, job title, expertise, company, type of organization, salary (e.g., period and amount), date of posting, job type, industry, and the like. As illustrated in FIG. 10, the search inputs may be listed in expandable and collapsible sections for each available criterion. Within each section, available values for that criterion may be listed. These available values may be derived from the universe of all values or a top predetermined number of values associated with job postings for a specific criterion. For example, if the top five locations for the job postings are Redmond, San Diego, Washington, D.C., Paris, and Beijing, these five locations may be listed as available values in the section for the location criterion.

In an embodiment, an advanced-search user interface for searching for available jobs (e.g., that have been posted through the jobs module) is provided. The user interface may comprise one or more inputs for specifying search criteria. If a user submits search criteria, the search results may be displayed in a similar manner as shown in FIG. 10. Examples of search criteria may include keywords, an indication of how to combine the keywords in a search query (e.g., require that all keywords be found in order to constitute a match, require that only one keyword be found in order to constitute a match, etc.), one or more locations (e.g., country, city, state, and/or postal code and/or a radius specified in miles), a job-posting time frame (e.g., jobs posted in the last day, week, month, thirty days, etc.), one or more industries, one or more organization types (e.g., corporation, public accountant, law firm, government, university, etc.), education and/or certification requirements (e.g., high school, AA, BA/BS, MST/MS, MBA, CPA, Chartered, JD, LLB, LLM, Ph.D, EA, etc.), job type (e.g., full-time, part-time, contract, consultant, flex-time, job-sharing, temporary, internship, etc.), salary range (e.g., minimum and maximum salary), an option to exclude jobs without salary information from search results, exclusion keywords (e.g., keywords that, if included in a job posting, will prevent the job posting from being included in search results), exclusion job title, exclusion company, etc.

In an embodiment, a job-creation user interface for creating a new job posting is provided. The user interface may comprise one or more inputs for specifying information for a new job opportunity. For example, this information may comprise a contact name, contact title, contact email address, contact phone number, job type (e.g., full-time, part-time, contract, consultant, flex-time, job-sharing, temporary, internship, other, etc.), title of job, tax title, tax expertise(s) required, description of the job, educational or certification requirements (e.g., high school, AA, BA/BS, MST/MS, MBA, CPA, Chartered, JD, LLB, LLM, Ph.D, EA, other, etc.), years of experience required (e.g., minimum and maximum years), salary range (e.g., minimum and maximum salary), indication that salary range depends on experience and should not be listed, company organization type, company industry, company name, company address (e.g., street, city, state, postal code, country), company logo (e.g., input for selecting and uploading image), company website URL, company profile, and poster's role (e.g., corporate recruiter, executive/agency recruiter, tax professional, other, etc.).

Once an employer user submits the information for a new job posting, the user may be provided a user interface for previewing the job posting prior to publication. In embodiments that require a user to pay to post a job opportunity, the user interface (or a separate user interface) may also provide inputs for paying for the job posting, such as a name on a credit card, credit card number, card type, expiration date (e.g., month and year), security code, etc. This payment information may be stored and automatically charged whenever the user submits a new job posting.

In an embodiment, a budget user interface for specifying a budget for job postings is provided. The user interface may comprise one or more inputs for managing costs. For example, the inputs may allow a user to set a total budget (e.g., a maximum amount that the user is willing to pay), a maximum cost per click (e.g., the highest amount that the user is willing to pay for a click on a job advertisement), a maximum cost-per-impression that the user is willing to pay per number of impressions (e.g., per one-thousand impressions) for a job advertisement, a maximum cost per application that the user is willing to pay per application obtained through a job advertisement, etc. In this manner, a user can manage its costs. For instance, the job module or other module (e.g., an advertisement module) may present advertisements for a job posting through the web application on platform 110, and charge the user per click, impression, and/or application submitted. Once the charges reach the specified total budget, the module may prevent any further advertisements for the user from being presented, thereby preventing the user from incurring any more charges. In addition, the specified maximum costs per click, impression, or application can be used to determine an advertisement's placement on various web pages of the web application. For example, a higher cost-per-click, -impression, or -application maximum will enable the advertisement to be presented on higher-cost “real estate” of the website (e.g., at the top of the homepage), while lower maximums will result in the advertisement being placed on lower-cost “real estate” of the web application (e.g., on a subsidiary page of the website). The total budget and maximums may be for all posted job opportunities or be independently set for each job opportunity posted. The user interface may also comprise inputs for entering a payment method, as described above.

In an embodiment, a report user interface for presenting a report to an employer user who has posted job opportunities is provided. The report may comprise a list of all or a subset (e.g., resulting from a search based on one or more criteria) of job opportunities that the employer user has posted. For each job opportunity, the list may comprise the number of applications (e.g., résumés) submitted, the number of impressions (i.e., views), the number of clicks, the total cost incurred (e.g., from impressions, clicks, and/or applications), the budget set for the job opportunity, the cost incurred for each application submitted, the status (e.g., active, inactive, pending, etc.), as well as an input or link for editing the job opportunity (e.g., editing the description, changing the status, etc.).

In an embodiment, an applications user interface for viewing a list of applications submitted for one or more job opportunities is provided. The user interface may comprise one or more inputs which allow an employer user to filter applications based on one or more criteria (e.g., title, location, expertise, etc.). The list may be provided for each individual job opportunity or for all job opportunities, or both. The list may comprise, for each application submitted, the date of submission, the name of the applicant, the title and current employer of the applicant, the tax expertise of the applicant, the location of the applicant, etc. If the employer user clicks on an application in the list, the user may be directed to a more detailed view of the application, as well as further user interfaces for managing the application (e.g., contacting the applicant, scheduling interviews, accepting or denying the application, send the applicant an interest letter, send the applicant a no-interest letter, etc.).

In an embodiment, a job-description user interface for displaying a posted job opportunity is provided. The user interface may comprise inputs for submitting an application to the posted job opportunity and/or sharing the job posting (e.g., by providing an email address to which the messaging module should email information about the job posting, including, for example, a URL to the job-description user interface). The job-description user interface may comprise all or a portion of the information that was entered when the job posting was created. For example, this information may comprise a company name, job location, company profile, job description, job title, industry, contact information, URL for a company website, job type, education requirements, years of experience required, salary information, etc.

In an embodiment, the jobs module and/or marketing module may also provide features for marketing an employer to potential employees. For example, an applicant-search user interface may be provided which comprises one or more inputs for performing a search for potential employees (e.g., from among professional members). An input may be provided for virtually any criteria that can be matched to a member. For example, inputs may be provided for filtering based on keywords, languages spoken, title, expertise, experience level and/or field, industry, current and/or previous employers, company revenue, public accounting firm name, law firm name, undergraduate degree, graduate degree, law degree, advanced law degree, associations, communities, location (e.g., within a range of a location specified by city, state, country, and/or postal code), interest in one or more types of employment (e.g., full-time, part-time, flex-time, contract, consultant, job-sharing, temporary, internship, etc.), etc.

In an embodiment, an employer user can also create a job opportunity which can be marketed to each potential employee identified in a search or from a selected contact group. For example, the created job opportunity may be utilized to generate a marketing letter or email message, e.g., using a template. The template may comprise identifiable fields or tags, which the marketing module can replace with personal information from the potential employee's profile (e.g., name) as well as information from the created job opportunity (e.g., title, company, company location, company profile, job description, contact information, etc.). The employer user may be provided with a preview of the marketing message prior to it being sent. The employer user may also be provided an opportunity to remove or add members to the list of recipients for the marketing message. Once the employer user is satisfied with the marketing message and list of recipients, the employer user may submit the message, and the jobs module will send the message to each of the recipients in the list of recipients. The jobs module may provide a record of the marketing message (e.g., date sent, title, name of list to which the message was sent, number of opens, status, etc.), as well as analytics concerning the marketing message (e.g., number of replies, applications submitted in response to the message, etc.).

19. Mergers and Acquisitions Team

In an embodiment, the web application may facilitate mergers and acquisitions of professional practices, such as tax accounting practices and/or tax consulting practices. Specifically, the web application may support interactions between users and a Mergers and Acquisitions Team, for example, provided by the operator of the web application, comprised of one or more registered professional members, and/or empaneled as a panel or instantiated as a community within the web application. The Mergers and Acquisitions Team may help professional members or other entities to sell or purchase professional practices.

20. Professional Panels

In an embodiment, the web application enables the creation and management of professional panels comprising one or more professional members. For example, a panel may be created by an administrator of the web application or by one or more professional members (e.g., by a professional member having certain roles and/or permissions, or alternatively by any professional member). In an embodiment, a professional member may achieve membership on a professional panel based on his or her level of activity and/or reputation (e.g., derived from feedback submitted about the user) on the web application. The web application may provide a single panel or a plurality of panels. A panel may comprise a plurality of professional members of varying expertise, and may be related to one or more expertise(s) and/or topic(s). Membership on panels may change periodically. For example, new panel(s), comprising new professional members, may be created or “convened” each week. In addition, each panel may be created to address a particular topic or topics.

In an embodiment, a user interface for viewing upcoming panels or panelists is provided. A navigable calendar may be provided. The user may click on dates or select date ranges on the calendar and view upcoming panels and/or the panelists for each upcoming panel on that date or within that date range (e.g., within one or two days, a week, etc.). The user interface may comprise one or more inputs which allow a user to search for a panel (e.g., by topic and/or date), as well as select a panel for viewing.

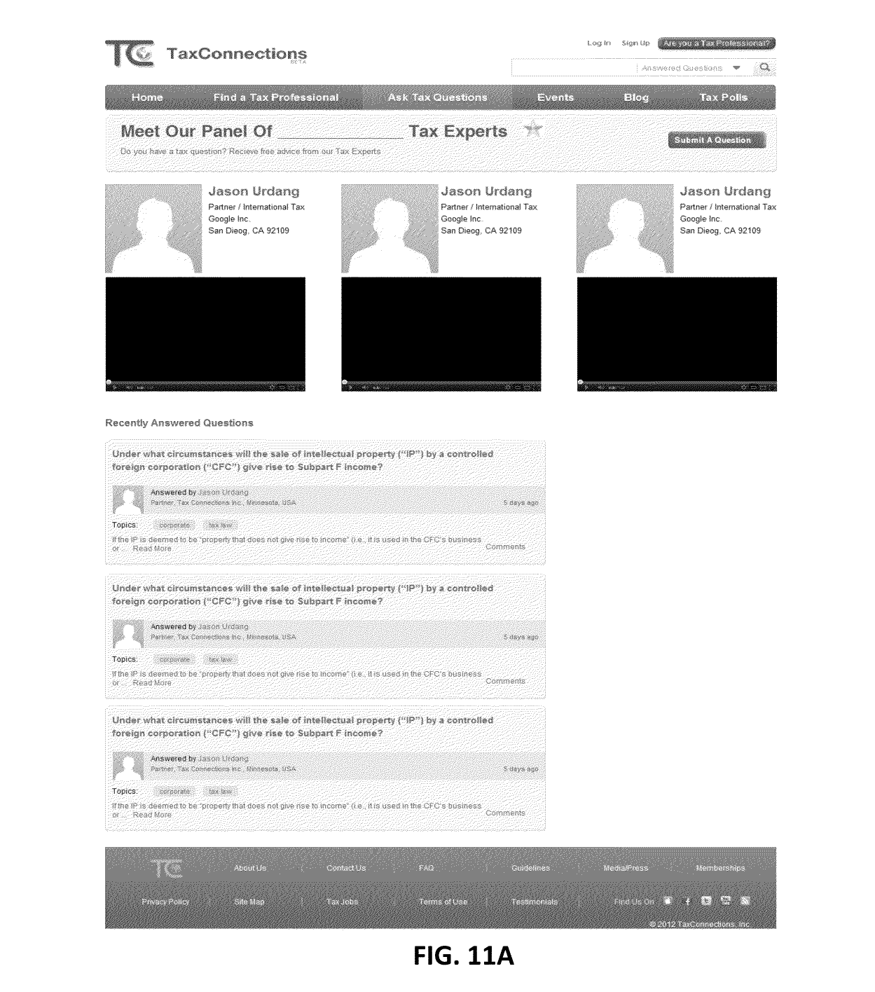

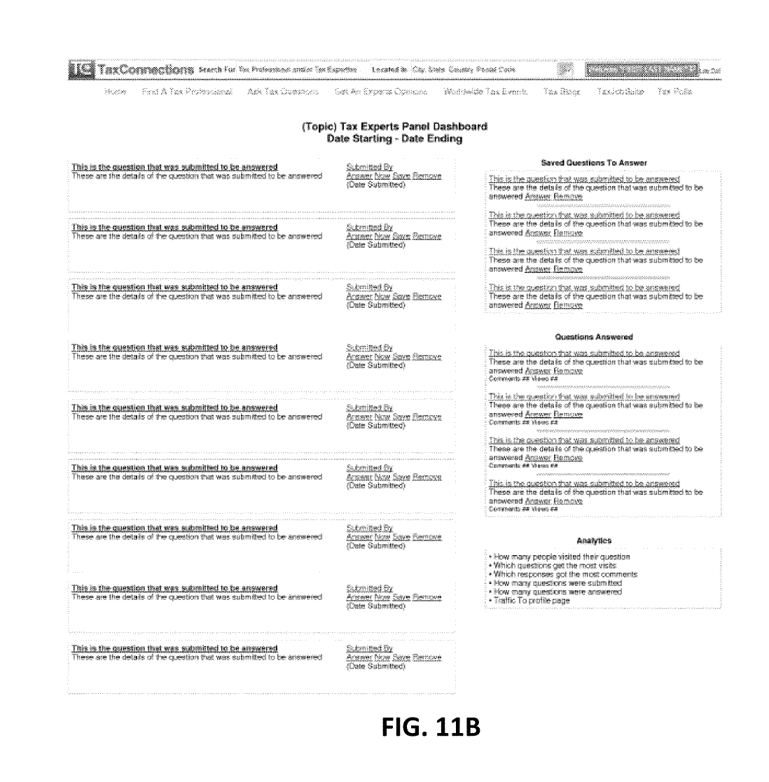

FIG. 11A illustrates a user interface for viewing a panel of experts (e.g., tax experts), according to an embodiment. A user may utilize one or more inputs of the user interface to submit a question to the panel. The user interface may provide condensed profiles for one or more of the members of the panel. In addition, the user interface may also provide a list of one or more questions recently answered by members of the panel, including the question, an identification of a questioner and/or respondent (e.g., name, title, company, location, etc.), date, topic tags, a portion or snippet of the answer, comments, etc. The user interface may also comprise one or more inputs, or a hyperlink to a user interface comprising one or more inputs, which allow a user to direct a question to a particular panel member or to all panel members, enter the question, and/or provide more details about the question. Furthermore, the user interface may comprise one or more inputs, or a hyperlink to a user interface comprising one or more inputs, which allow a user to comment on questions, answers, and/or other comments.

In an embodiment, a panel-members user interface is provided for viewing a list of previously and/or currently empaneled members, and/or for viewing members on a selected panel. The user interface may allow a user to search for experts (e.g., based on name), select a name of a member of a previous and/or current panel (e.g., from a drop-down menu), and search by topic. The list of members and/or search results may comprise a record for each member comprising, for example, the member's name, title, expertise(s), company, location, role on the panel (e.g., the expertise being contributed by the member to the panel), etc. The user interface may allow a user to search for additional information about the panel members, e.g., by expert or topic. If a user searches by expert or selects an expert, the search results may comprise all answers to tax questions and/or other posts (e.g., comments, blog entries, etc.) that the selected expert has submitted. If the user searches by topic, the search results may comprise all answers to tax questions and/or other posts that the members of the panel have submitted on the topic.

In an embodiment, a user interface for applying to join a panel is provided. The user interface, which may only be accessible to professional members, may comprise one or more inputs which allow a professional member to select one or more topics in which he or she wants to be recognized as an expert, enter dates that he or she is available, enter a brief summary of his or her experience and/or technical strengths, and/or accept terms of use and/or guidelines applicable to panelists.

FIG. 11B illustrates a panel dashboard available to panelists on a panel. The dashboard can comprise one or more frames, which allow a panelist member to manage his or her role in the panel. For example, a first frame may comprise a list of questions that have been submitted (e.g., and not answered by the panelist or panel). Each row in the list may comprise the question, name or identifier of the user who submitted the question, date submitted, and inputs for answering, saving, or removing the question from the list. A second frame may comprise a list of questions that the panelist member has saved, e.g., by selecting the save input from the list of questions in the first frame. A third frame may comprise a list of questions that the panelist member has answered, e.g., by selecting the answer input from the list of questions in the first frame and entering one or more inputs into a resulting user interface for answering a question. In addition, a fourth frame or set of inputs (e.g., hyperlinks) may allow the panelist member to view analytics regarding the panel, such as how many users visited a question, which questions get the most visits, which responses get the most comments, how many questions were submitted, how many questions were answered, how much traffic has been generated to the panelist member's profile page, etc.

In an embodiment, a member can select one or more criteria for panel alerts. If a panel is empaneled that meets the one or more criteria, the messaging module can notify the member via one or more messages. For example, the member may select one or more topics. Whenever a panel is established for the selected topic(s), an alert can be sent to the member notifying the member about the panel, providing a link to a user interface comprising panel information (information about panelists, questions to the panelists, answers or comments from the panelists, etc.), etc.

Additional Features

In embodiments, additional features may be implemented by one or more additional or previously described modules.

In an embodiment, syndicated content (e.g., Twitter™ feeds related to, for example, tax information, a blog, etc.) may be aggregated and displayed by the web application. For example, a professional may specify a URL for his or her syndicated content (e.g., Twitter™ feed or blog), as well as other information (e.g., blog title, description, topic or type, world region, etc.), and the syndicated content may be retrieved and displayed by the web application. In addition, links to different related blogs (e.g., tax blogs) may be provided. These features may be in addition or as an alternative to other functions of the blog module described elsewhere herein.

In an embodiment, the registration module may be configured to provide members with a free trial subscription. With a free trial subscription, a professional member may be allowed to utilize member-only features of the web application for free for a predetermined time period (e.g., thirty days). The member may be required to provide payment information (e.g., credit card information), which will be utilized to automatically bill the member if the member fails to cancel his or her subscription following the predetermined time period.

In an embodiment, platform 110 may also host a salary survey module. Professional members may choose to participate in the annual survey, for example, by providing one or more inputs before, during, and/or subsequent to the registration process. The professional member may also identify one or more individuals (e.g., by entering email addresses associated with contacts or colleagues) to invite to participate in the salary survey, and the salary survey module may send out invitations (e.g., via email) to the identified individuals. The salary survey module may provide a user interface through which a user can submit compensation information for one or more years. The compensation information may include the year of compensation, base compensation, bonus amount(s), stock options or grants, etc. This compensation information may be collected across a plurality of users (e.g., professional members) and used in combination with the users' profile as an informational or analytical tool. For example, the compensation information and profiles may be analyzed to determine average compensation across a profession, area of expertise, level of experience, for a particular geographic region, etc.

In an embodiment, a registering user may be prompted to identify a member who referred the registering user to the web application of platform 110. For example, an input may be provided for entering an email address, name, or other identifier of the referring member. According to a further embodiment, the referring member may receive an incentive (e.g., cash incentive, reduction in subscription fee, reward points, increase in reputation, a higher weighting coefficient or tier for better search placement, etc.) for each registered user that he or she has been identified as referring to the web application.

In an embodiment, server(s) 110 may also host a job description module. The job description module may provide a filterable and/or sortable library or dictionary of job descriptions. For example, the library may be filterable or sortable by keyword, organization type, country, etc. In an embodiment, inputs may be provided which enable a user to submit new job descriptions to the library. The library may be presented as a user interface with a list of job titles. This list may be segregated into a plurality of frames representing a plurality of different organization types (e.g., corporate tax titles, public accounting titles, law firm titles, government titles). For example, a list of corporate tax titles may comprise Vice President Tax, Tax Director, Senior Tax Manager, Tax Manager, Tax Supervisor, Tax Senior, Tax Analyst, Property Tax Manager, State and Local Tax Manager, Sales and Use Tax Manager, etc. As another example, a list of law firm titles may comprise Managing Tax Partner, Tax Partner, Of Counsel, Senior Associate, Associate, etc. Each title in the list may be selectable. For instance, if a user selects a title, the user may be provided with a typical job description for the title. Employer users can use such a library, for example, to help construct a job opportunity for posting, e.g., by selecting an appropriate title or job description.

In an embodiment, the web application may provide a set of premium services and/or analytics to paying members. For example, the application may allow premium users to select keywords to search for specific technical skills and experience that the user is searching for in a tax professional, search for professionals that the user would like to approach about a professional opportunity, send a direct message to qualified professionals with experience related to a professional opportunity, maintain one or more lists of professionals with specialized skills and expertise, access a library of written job descriptions and/or other resources, manage and track all job postings, access annually conducted salary surveys, and/or connect with parties interested in selling or purchasing a professional practice (e.g., tax practice).

Example Processing Device

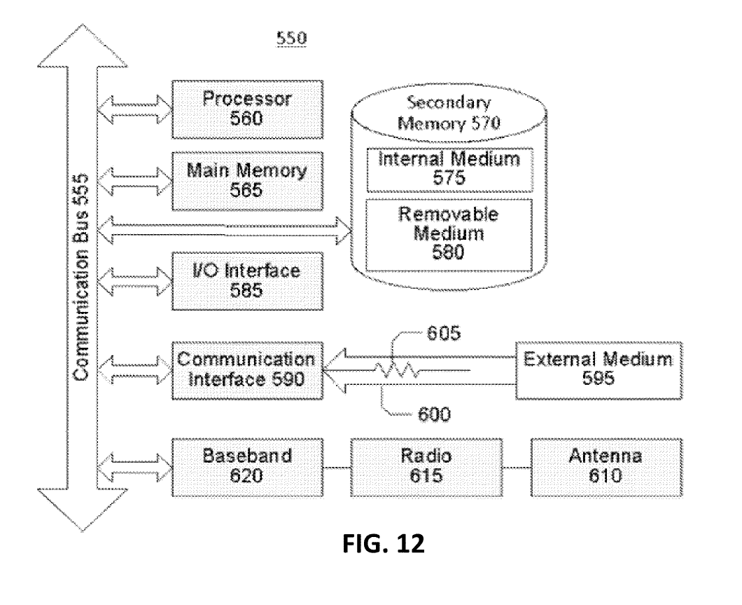

FIG. 12 is a block diagram illustrating an example wired or wireless system 550 that may be used in connection with various embodiments described herein. For example the system 550 may be used as or in conjunction with one or more of the mechanisms or processes described above, and may represent components of server(s) 110, user system(s) 130, and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Perl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA, or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method for searching for professionals within an online community, the method comprising using at least one hardware processor to:
manage at least one database comprising member information for each of a plurality of members, wherein the plurality of members comprise a plurality of professional members and a plurality of non-professional members;
store activity information for one or more interactions between one or more of the plurality of professional members and a web application;
store feedback information received for one or more of the plurality of professional members;
receive one or more search requests from at least one of the plurality of non-professional members, wherein each of the one or more search requests comprises one or more search criteria; and
for each of the one or more search requests,
identify two or more of the plurality of professional members based on the membership information for each of the two or more professional members and the one or more search criteria,
determine an order for the identified two or more professional members based on the activity information and the feedback information for the identified two or more professional members, and
generate a list comprising the identified two or more professional members in the determined order.

2. The method of claim 1, further comprising generating a virtual boardroom for each of the plurality of professional members, wherein each virtual boardroom comprises a communications interface for communicating between the associated professional member and one or more contacts of the associated professional member, contact information for the one or more contacts, a notebook interface for managing information about the one or more contacts, and a library interface for managing electronic documents shared between the associated professional member and the one or more contacts.

3. The method of claim 1, further comprising, for each of the plurality of professional members, assigning a weighting coefficient to the professional member based on the activity information and the feedback information for the professional member, wherein determining an order for the identified two or more professional members is based on the weighting coefficients assigned to the identified two or more professional members.

4. The method of claim 3, further comprising, for each of the plurality of professional members, assigning the professional member to one of a plurality of tiers based on the weighing coefficient assigned to the professional member, and wherein determining an order for the identified two or more professional members is based on the tiers assigned to the identified two or more professional members.

5. The method of claim 1, further comprising:
receiving one or more questions from at least one of the plurality of non-professional members;
for each of the one or more questions, identifying an interaction between at least one of the plurality of professional members and the web application, wherein the interaction comprises one or more of receiving an answer to the question from the at least one professional member, receiving a comment from the at least one professional member on an answer, and receiving a comment from the at least one professional member on a comment; and
storing an indication of the identified interaction as activity information associated with the at least one professional member.

6. The method of claim 1, further comprising:
receiving feedback for at least one of the plurality of professional members, wherein the feedback comprises one or more of a rating of an answer received from the at least one professional member, a rating of a comment received from the at least one professional member, and a recommendation received for the at least one professional member; and
storing an indication of the feedback as feedback information associated with the at least one professional member.

7. The method of claim 1, further comprising:
assigning two or more of the plurality of professional members to a panel;
receiving one or more questions for the panel from one or more of the plurality of members;
providing the one or more questions to one or more of the two or more professional members on the panel; and
receiving one or more answers to the one or more questions from one or more of the two or more professional members on the panel.

8. The method of claim 7, further comprising determining a reputation for each of the plurality of professional members based on the activity information and the feedback information, and wherein assigning the two or more professional members to the panel comprises selecting the two or more professional members for the panel based on the reputation determined for each of those two or more professional members.

9. The method of claim 1, further comprising, for each of the plurality of professional members, determining a reputation of the professional member for each of a plurality of expertises based on the activity information and the feedback information.

10. The method of claim 1, wherein the plurality of members further comprise a plurality of employer members, and wherein the method further comprises:
receiving at least one job opportunity from at least one of the plurality of employer members;
receiving a budget for the at least one job opportunity from the at least one employer member;
determining a placement on a website of the web application for the at least one job opportunity based on the budget;
providing an advertisement of the at least one job opportunity at the determined placement on the website;
receiving one or more applications to the at least one job opportunity from one or more of the plurality of professional members; and
providing the one or more applications to the at least one employer member.

11. A system for searching for professionals within an online community, the system comprising:
at least one hardware processor;
at least one database comprising member information for each of a plurality of members, wherein the plurality of members comprise a plurality of professional members and a plurality of non-professional members; and
one or more executable software modules configured to, when executed by the at least one hardware processor,
store activity information for one or more interactions between one or more of the plurality of professional members and a web application,
store feedback information received for one or more of the plurality of professional members,
receive one or more search requests from at least one of the plurality of non-professional members, wherein each of the one or more search requests comprises one or more search criteria, and
for each of the one or more search requests,
identify two or more of the plurality of professional members based on the membership information for each of the two or more professional members and the one or more search criteria,
determine an order for the identified two or more professional members based on the activity information and the feedback information for the identified two or more professional members, and
generate a list comprising the identified two or more professional members in the determined order.

12. The system of claim 11, wherein the one or more executable software modules are further configured to generate a virtual boardroom for each of the plurality of professional members, wherein each virtual boardroom comprises a communications interface for communicating between the associated professional member and one or more contacts of the associated professional member, contact information for the one or more contacts, a notebook interface for managing information about the one or more contacts, and a library interface for managing electronic documents shared between the associated professional member and the one or more contacts.

13. The system of claim 11, wherein the one or more executable software modules are further configured to, for each of the plurality of professional members, assign a weighting coefficient to the professional member based on the activity information and the feedback information for the professional member, wherein determining an order for the identified two or more professional members is based on the weighting coefficients assigned to the identified two or more professional members.

14. The system of claim 13, wherein the one or more executable software modules are further configured to, for each of the plurality of professional members, assign the professional member to one of a plurality of tiers based on the weighing coefficient assigned to the professional member, and wherein determining an order for the identified two or more professional members is based on the tiers assigned to the identified two or more professional members.

15. The system of claim 11, wherein the one or more executable software modules are further configured to:
receive one or more questions from at least one of the plurality of non-professional members;
for each of the one or more questions, identify an interaction between at least one of the plurality of professional members and the web application, wherein the interaction comprises one or more of receiving an answer to the question from the at least one professional member, receiving a comment from the at least one professional member on an answer, and receiving a comment from the at least one professional member on a comment; and
store an indication of the identified interaction as activity information associated with the at least one professional member.

16. The system of claim 11, wherein the one or more executable software modules are further configured to:
receive feedback for at least one of the plurality of professional members, wherein the feedback comprises one or more of a rating of an answer received from the at least one professional member, a rating of a comment received from the at least one professional member, and a recommendation received for the at least one professional member; and
store an indication of the feedback as feedback information associated with the at least one professional member.

17. The system of claim 11, wherein the one or more executable software modules are further configured to:
assign two or more of the plurality of professional members to a panel;
receive one or more questions for the panel from one or more of the plurality of members;
provide the one or more questions to one or more of the two or more professional members on the panel; and
receive one or more answers to the one or more questions from one or more of the two or more professional members on the panel.

18. The system of claim 17, wherein the one or more executable software modules are further configured to determine a reputation for each of the plurality of professional members based on the activity information and the feedback information, and wherein assigning the two or more professional members to the panel comprises selecting the two or more professional members for the panel based on the reputation determined for each of those two or more professional members.

19. The system of claim 11, wherein the one or more executable software modules are further configured to, for each of the plurality of professional members, determine a reputation of the professional member for each of a plurality of expertises based on the activity information and the feedback information.

20. The system of claim 11, wherein the one or more executable software modules are further configured to:
receive at least one job opportunity from at least one of the plurality of employer members;
receive a budget for the at least one job opportunity from the at least one employer member;
determine a placement on a website of the web application for the at least one job opportunity based on the budget;
provide an advertisement of the at least one job opportunity at the determined placement on the website;
receive one or more applications to the at least one job opportunity from one or more of the plurality of professional members; and
provide the one or more applications to the at least one employer member.
